(19) United States
(12) Patent Application Publication
(10) Pub. No.: US 2018/0204474 A1
(43) Pub. Date: Jul. 19, 2018

(54) Swim Lap Counting and Timing System and Methods for Event Detection from Noisy Source Data

(71) Applicant: Ocula Corporation, Kensington, CA (US)

(72) Inventor: Robert L. Firmin, Kensington, CA (US)

(21) Appl. No.: 15/859,679

(22) Filed: Jan. 1, 2018

Related U.S. Application Data
(62) Division of application No. 15/449,323, filed on Mar. 3, 2017.
Application No. 15/449,323 is a continuation of application No. PCT/US2016/030977, filed on May 5, 2016.
Application No. PCT/US2016/030977 is a continuation-in-part of application No. 14/705,542, filed on May 6, 2015, now Pat. No. 9,217,634.
Application No. 15/449,323 is a continuation-in-part of application No. 14/937,474, filed on Nov. 10, 2015, now Pat. No. 9,778,622.
Application No. 14/937,474 is a continuation of application No. 14/705,542, filed on May 6, 2015, now Pat. No. 9,217,634.
(60) Provisional application No. 62/318,069, filed on Apr. 4, 2016.

(51) Int. Cl. G09B 5/02; A63B 33/00; A63B 71/06; A63B 24/00; G09B 19/00

(52) U.S. Cl. CPC G09B 5/02; A63B 33/002; A63B 71/0619; A63B 71/0686; A63B 24/0006; G09B 19/003; A63B 2220/17; A63B 2071/0666; A63B 2220/40; A63B 2220/836; A63B 2230/06; A63B 2230/75; A63B 2024/0012

(57) ABSTRACT

Systems and methods for lap timing and counting in athletic events are disclosed. The systems and methods do not require the athlete to wear a counter/timer, a transmitter, a reflector or another kind of marker. A portable computing device with a sensor, such as a tablet computer with a camera, is positioned in an appropriate location. Data from the sensor is transformed into a time series of data, and one or more learned statistics are calculated in real time as benchmark ambient conditions. The learned statistics are essentially continuously updated and data that indicates irrelevant volatility is excluded. A detection threshold is determined and essentially continuously updated based on the learned statistics, and lap completion is determined based on the threshold. Times, lap counts, and other data are displayed on the portable device in real time.

### CROSS-REFERENCE TO RELATED APPLICATIONS

This application is a division of U.S. application Ser. No. 15/449,323, filed Mar. 3, 2017, which is a continuation of International Application No. PCT/US2016/030977, filed May 5, 2016, which claims priority to U.S. application Ser. No. 14/705,542, filed May 6, 2015, and to U.S. Provisional Application No. 62/318,069, filed Apr. 4, 2016. U.S. application Ser. No. 15/449,323 is also a continuation-in-part of U.S. application Ser. No. 14/937,474, filed Nov. 10, 2015, which is a continuation of U.S. application Ser. No. 14/705,542, filed May 6, 2015. The contents of all of those applications are incorporated by reference in their entireties.

### TECHNICAL FIELD

The invention relates to systems for counting and timing laps in athletic events, and to methods for event detection from noisy source data.

### BACKGROUND

Swimming as a sport dates to the ancient Greeks and has been a competitive sport in every modern Olympics. A number of high-profile national and Olympic competitors in recent years have only made it more popular. In competitive swimming events, the swimmers swim one or more lengths of a pool, each two lengths equaling one lap, turning at each end of the pool to begin the next length. For serious and competitive swimmers, counting and timing these laps is important in measuring individual progress toward goals, as well as in determining the winner of any particular race. For recreational swimmers and those who only swim for health, the distance covered is often of primary importance, with distance measured by the number of laps. Lap counting without external aids occupies a swimmer's thoughts and is tedious and unreliable, aside from which it can be very difficult to judge one's progress and observe distance and time during a swim, especially since most devices used to do so are out of the water or are attached to the body.

In officially-sanctioned competitive races, touch pads are usually provided at the ends of the pool, and as the swimmers turn to begin a new lap, they toggle the pad, which provides both verification that the lap has been properly completed and an accurate time for the lap. As accurate and accepted as these systems are, they are typically only available to competitors swimming in appropriately-equipped pools, and can cost many thousands of dollars. They are not designed for use by individuals, but rather for teams supervised by coaches. These types of devices are rarely used for individual workouts.

Timing and counting systems for individual swimmers and pools not equipped with touchpads are available. U.S. Pat. No. 5,125,010, for example, is representative of a class of devices that use a poolside unit and a wearable transmitter to time the swimmer and count laps. The poolside unit communicates with the transmitter, which is attached to the swimmer. In this patent, the two devices communicate with each other using radio frequencies, although other examples of lap counters, like the system disclosed in U.S. Pat. No. 4,823,367, attach a passive marker to the swimmer and reflect energy, like infrared beams, off of it. These types of systems continue to be made and improved; U.S. Pat. No. 6,870,466 discloses a more recent example of this type of system. A variation on this is disclosed in U.S. Patent Application Publication No. 2014/0200116, which uses a machine vision system coupled with an optical marker mounted near the swimmer's hips. All of the above-described patents are incorporated by reference in their entireties.

Systems that use a fixed unit and a portable transmitter, reflective marker, or counting unit on the swimmer have significant drawbacks. For example, the portable transmitter or marker may be uncomfortable to wear, or may cause significant drag or turbulence around the swimmer, thereby affecting biomechanics and performance. In addition, the motion of the swimmer and the environment of the water—with turbulence and thousands of disruptive bubbles—can potentially cause unreliable communications. Certain types of communications are particularly susceptible to this kind of disruption. For example, absorption of infrared light is stronger in water than in air, and laser light is particularly susceptible to disruption by bubbles.

For the reasons described above, and many others, collecting and providing accurate, real-time timing and lap count information to a swimmer is difficult. Thus, while there have been many attempts to create systems that individual swimmers can use to time themselves and count laps, none of them have found wide acceptance or use.

### SUMMARY OF THE INVENTION

Embodiments of the invention relate to methods and systems for detecting laps and other types of motion-based events. They can be used for swimming, for other athletic workouts and events, and in some cases, for non-athletic purposes. Using these methods and systems, an athlete is not required to wear a marker, reflector, transmitter, or transponder for lap counting and timing and can thus employ his or her usual form or biomechanics without interruption or modification.

Methods according to embodiments of the invention transform data from a sensor placed to observe the end of a lap, or another type of event, into a time series. For example, these methods may use data from a camera of a tablet computer and may transform that data into a series of data values indicating the level of incident light. The methods then calculate one or more learned statistics, such as a learned ambient mean and a standard deviation, based on the data values. This is done selectively, typically excluding data values during certain time periods that indicate more volatile non-ambient conditions and would bias the results, including only data values indicating a change that is relevant to detection, and periodically checking for a secular shift in the level of the learned statistics. The learned statistics are essentially continuously updated as time passes. A detection threshold is determined based on the learned statistics, and the methods detect the end of a lap when the data values exceed the threshold. The methods may also provide for storage of images and video of the event, allowing for a wide range of post-event evaluation and processing tasks.

These methods may be implemented on dedicated and purpose-built computing systems, but in many embodiments, they may be implemented using existing commercial portable computing devices, such as tablet computers. In that case, the onboard camera, or another onboard sensor, may be used to gather data for the methods. These systems may be networked, so that athletes who in other lanes of the pool or who are geographically separated may compete against one another and see their relative progress in real time on their own device's display. Data from the systems may be uploaded to and stored on a remote server for post-analysis and other purposes. Individual segments of a swimming workout may be planned ahead of time, and post-swim analysis may include, for example, lap times, changes in speed, speed of turns, and times by different strokes, with results sharable in social media and on other platforms.

These and other aspects, features, and advantages of the invention will be set forth in greater detail in the following description.

### BRIEF DESCRIPTION OF THE DRAWING FIGURES

The invention will be described with respect to the following drawing figures, in which like numerals represent like features throughout the figures, and in which:

FIG. 1 is an illustration of a swim lap counting and timing system according to one embodiment of the invention;

FIG. 2 is a perspective view of the system of FIG. 1;

FIG. 3 is a high-level flow diagram of a method for determining when a swimmer has passed a defined position to complete a lap and for timing laps;

FIG. 4 is an illustration of a system for facilitating communication, pacing, and competition between swimmers using the system of FIGS. 1 and 2 communicating via a network;

FIG. 5 is a graph of luminance data taken from a camera sensor positioned at the bottom of a pool;

FIG. 6 is a flow diagram of the tasks involved in differentiating signal from noise and for detecting events in the method of FIG. 3;

FIG. 7 is a comparison graph showing unmodified and modified luminance data;

FIG. 8 is a schematic diagram of a swim lap counting and timing system according to another embodiment of the invention;

FIG. 9 is an illustration of a method of setting a defined point or plane for detection and of determining position relative to that defined point or plane;

FIG. 10 is a perspective view of a swimming pool, illustrating one placement for the system of FIG. 8 and the projection of data onto the bottom of a swimming pool;

FIG. 11 is a perspective view of a swimming pool similar to the view of FIG. 10, illustrating the reversal of direction of the data projection or display when the swimmer turns;

FIG. 12 is a schematic elevational view of a swimming pool, illustrating another placement for the system of FIG. 8 and the projection of data onto the side wall of a swimming pool;

FIG. 13 is an illustration of a swimmer wearing an instrumented swim cap;

FIG. 14 is an illustration of a goggle-based heads-up display (HUD) or virtual retinal display (VRD) showing progress and vital sign information; and

FIG. 15 is a flow diagram of certain tasks involved in determining that an event has occurred relative to the diagram of FIG. 6.

### DETAILED DESCRIPTION

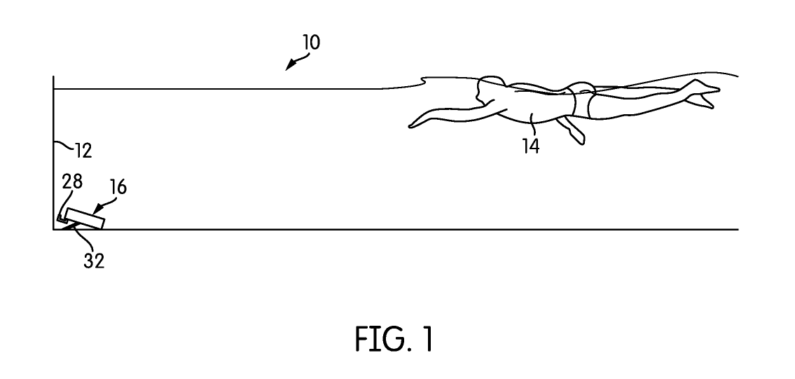

FIG. 1 is an illustration of one embodiment of a system, generally indicated at 10, according to one embodiment of the invention. More specifically, FIG. 1 illustrates a pool 12 with a swimmer 14 in the pool. A lap detection and timing system 16 is placed in the pool 12 in a position to detect the movements or passing of the swimmer 14. The system 16 may be placed in a variety of positions in and around the pool. In the illustration of FIG. 1, the system 16 is placed near one end of the swimming pool 12. However, as will be described and shown in more detail, the system 16 may be placed in any position where the system 16 can observe when the swimmer 14 reaches or passes a defined position, which is usually the position of the system 16 itself. If necessary, the system 16 can be weighted to remain at the bottom of the swimming pool 12, or it may be hung from the side of the pool.

When using system 16, the swimmer 14 is not required to don a transmitter, transponder, marker, or other wearable element in order to make the system work. Nor is the swimmer 14 required to physically toggle a switch or touch pad with each turn. In virtually all embodiments, the swimmer 14 him- or herself is unmodified and is able to maintain his or her natural stroke. The system 16 observes the position of the swimmer 14 and, using a time-series of data, determines when the swimmer passes over the defined position. In most implementations, although not all, the defined position will be a position in which the swimmer 14 passes over the system 16 or creates a specific disturbance in the water that is perceptible by the system 16.

System 16, and other systems according to embodiments of the invention, use detection mechanisms that rely on numerical methods to process sensor data and detect when the swimmer passes over the defined position. Thus, system 16 can detect that event regardless of the noisy environment of the water. Moreover, system 16 learns the ambient characteristics of the water in each specific pool during each specific swim as the swimmer swims. As the phrase is used here, “ambient conditions” refers to the conditions of the water near the system 16 that are recorded by the system but are unaffected, or largely unaffected, by the swimmer when the swimmer is not in close proximity to the system 16.

As will be explained below in greater detail, at the core of system 16 lies a sensor coupled to a computing device to process the sensor's data. While system 16 may be assembled using custom, purpose-built electronics, it need not be. Increasingly powerful commercial, off-the-shelf computing systems are readily available to consumers, and in most embodiments, it may be more advantageous if the computing device is an off-the-shelf computing device. Of course, system 16 may include various peripherals that are particularly adapted for its purpose.

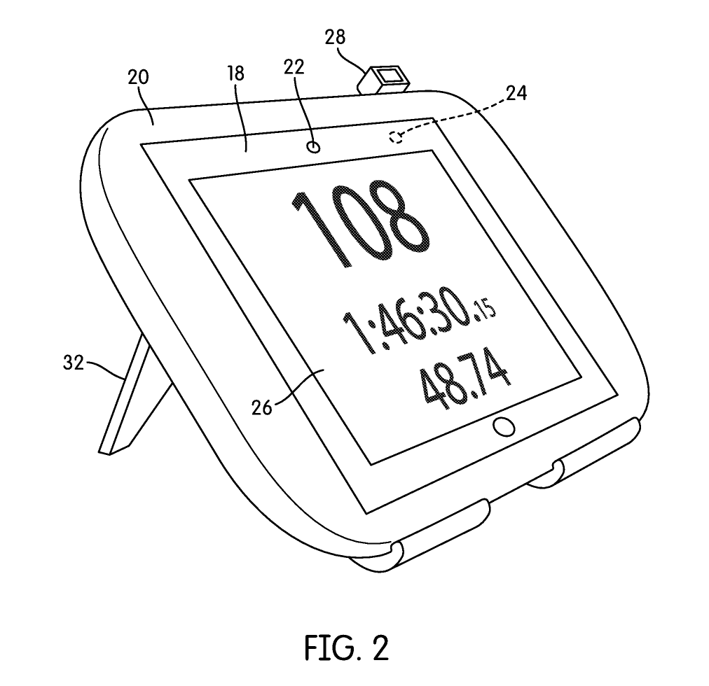

FIG. 2 is a perspective view of a system 16 according to one embodiment of the invention. In the view of FIG. 2, the system 16 includes a computing device 18 in a waterproof casing 20. In this embodiment, the computing device 18 is a commercial computing device, such as a tablet computer. For example, tablet computers like the Apple iPAD® and the Samsung GALAXY® are suitable for use. In some embodiments, smartphones and other smaller computers, like the Apple iPHONE® and cellular phones based on the ANDROID® operating system, may be used, although it is generally preferable to use larger tablet computers because the screen may be more visible when the device is under water and at a distance from the swimmer 14. The almost universal use of goggles, many including visual correction, makes viewing an underwater screen easy.

Commercial tablet computers have a large amount of computing power, often supplied by a microprocessor that is created or tailored for the application. Tablet computers also have a suite of onboard components and sensors, typically including a front camera 22 and a rear camera 24. Other instruments, like accelerometers and gyroscopes, may also be provided.

In most embodiments of the invention, one of the cameras 22, 24 is used as an optical sensor to determine whether the swimmer 14 has reached the defined position. The choice of camera 22, 24 depends on the characteristics of the cameras 22, 24. The cameras 22, 24 of many commercial tablet computers differ significantly in capabilities, with the front camera 22, the camera that faces the user while the device is in use, having a lower resolution (e.g., 1-2 megapixel (MP)), and the rear camera 24 having a larger resolution (e.g., 3-10 MP).

It is convenient to use the front camera 22 as the optical sensor for gathering data, so that the screen 26 of the computing device 18 and the camera 22 are both facing the swimmer 14. However, it is also helpful to use the highest resolution camera 22, 24 available as the optical sensor. Thus, depending on the resolutions of the two cameras 22, 24, it may be more advantageous to use the rear camera 24 in order to get the best data possible. For that reason, a periscope 28 may be coupled to the rear camera 24 so that the view of the rear camera 24 is redirected to the front of the computing device 18. The particular angle and field of view that the periscope 28 offers may vary from embodiment to embodiment.

The waterproof casing 20 may be rigid or it may be in the form of a flexible bag. For purposes of this description, the term “waterproof” means that the casing 20 resists water sufficiently well to allow the system 16 to operate underwater at an appropriate depth. For example, a casing 20 that is waterproof to a depth of 10-12 feet (3-4 m) may be sufficient in most embodiments. Of course, if the system 16 is designed to operate at a lesser depth, or even above the surface of the water, it may be sufficient for the casing 20 to resist only splashing and incidental contact with water. Commercially available electronics-friendly coatings may be applied to the system 16 for additional protection. Since the screen 26 of the computing device 18 is typically a touch screen, it is advantageous if the waterproof casing 20, or at least the portion of it over the touch screen 26, is equipped to convey the touch of a human finger to the screen 26. In many embodiments, this will mean that at least the portion of the casing 20 over the screen 26 is conductive. In some cases, spacers between the screen 26 and the casing 20 may be used in certain areas of the screen 26 to isolate portions of the screen 26 where buttons or controls are located so as to make touches in those areas more readily readable by the computing device 18. The system 16 of FIG. 2 also includes an angled stand 32 connected to the computing device 18 or case 20, so that the position of either or both of the screen 26 or the cameras 22, 24 is more convenient for the swimmer 14.

In use, the system 16 uses a software application to perform methods for detecting when the swimmer 14 reaches a defined point and other functions. A software application, as that term is used here, is a set of machine-readable instructions on a machine-readable storage medium that, when executed, cause the machine to perform certain functions. In the embodiment illustrated in FIG. 2, the machine in question is a tablet computer. In other embodiments, any device capable of performing the functions ascribed to it may be used. Software applications for portable computing devices like tablet computers are typically referred to as “apps.”

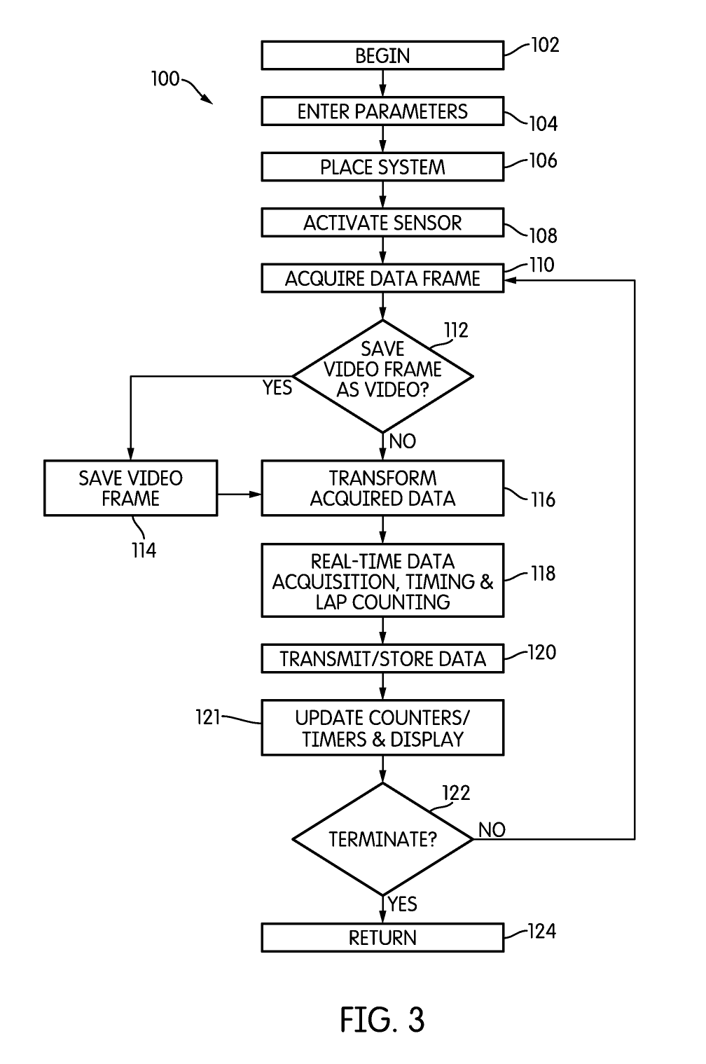

FIG. 3 is a flow diagram of a method, generally indicated at 100, for determining when a swimmer 14 has passed the position defined by the system 16 as indicating the end of a lap or the start of a new lap. While method 100 uses certain numerical and computational techniques, any techniques that can successfully separate signal from noise in the environment of the water may be used, and certain options will be described below in more detail. Method 100 begins at task 102 and continues with task 104.

In task 104, the swimmer 14 enters any optional parameters that are necessary for the system 16 to make accurate calculations for post-swim analysis. No additional parameters need be entered for lap counting and detection to work; thus, if the swimmer 14 desires only these functions, task 104 may be skipped. If desired for post-swim analysis, the swimmer 14 would, for example, select the length of the pool 12 and the number of laps that he or she desires to swim. The system 16 would generally include a number of standard pool lengths and configurations; the user may be given the opportunity to enter a nonstandard length. Data entry for task 104 and other tasks of method 100 may be by means of a keyboard, a simulated keyboard, or by graphical user interface (GUI) controls.

The swimmer may be permitted to enter additional parameters. Like all parameters of task 104, these additional parameters will generally be optional, necessary for additional features only, or for informational purposes. Additional parameters may include lap counting up vs. down; splits; number of multi-lap sets to swim; which stroke will be used for which lap or set of laps; a pace time against which to swim; time ahead or behind of a pace time; a drill pattern (i.e., allowing the swimmer 14 to define and specify sets of swim lengths and rest periods); display and encouragement options (text, screen color, video, and audio prompts to encourage the user); and whether or not to store video for later playback. As one example, a swimmer 14 might specify that he or she intends to swim freestyle for 30 laps, and do the breaststroke for another 6 laps with a 10-frame video of a coach or a loved one's face appearing on the screen 26 near the conclusion of the twenty-ninth lap. The swimmer 14 might further specify that video of the swim is to be stored for further analysis, and that he or she intends to swim against a pace corresponding to the performance of a famous or accomplished swimmer.

Some parameters may be set in the system 16 as defaults, but can be modified by the user in task 104. For example, the system 16 may use a green background color on the screen 26 if the swimmer 14 is at or ahead of the pace he or she has chosen, and a red background if the swimmer 14 is behind his or her chosen pace.

Although system 16 and method 100 provide accurate lap counts and times without the need for the swimmer 14 to wear anything, as will be described below in more detail, system 16 and methods like method 100 can make use of wearable peripherals to enable supplementary functions if they are available and if the swimmer 14 chooses to wear them. Some parameters may be used only if corresponding peripherals are also used. For example, the swimmer 14 may have the option to record stroke power if a load cell, strain gauge, or other such device is used, and to record strokes per lap if an accelerometer is used. The output of these peripherals may be communicated to and displayed in real time on the system 16. In most embodiments, parameters may be set in advance, and will be stored between workouts. Thus, particularly if the swimmer 14 is doing the same workout multiple times, even if parameters are used, task 104 may not be necessary in every iteration of method 100.

System 16 may also communicate with other systems 16 timing other swimmers in real time. Thus, swimmers 14 who are in the same pool 12, or swimmers 14 who are in different pools 12 that are geographically distant from one another, may compete against each other in a race or pace themselves against each other. If that is to be done, task 104 may involve allowing the swimmer 14 to set the parameters necessary to communicate with the system 16 being used by the other swimmer 14. These competitions may be in real time, or use stored split times from the other swimmers.

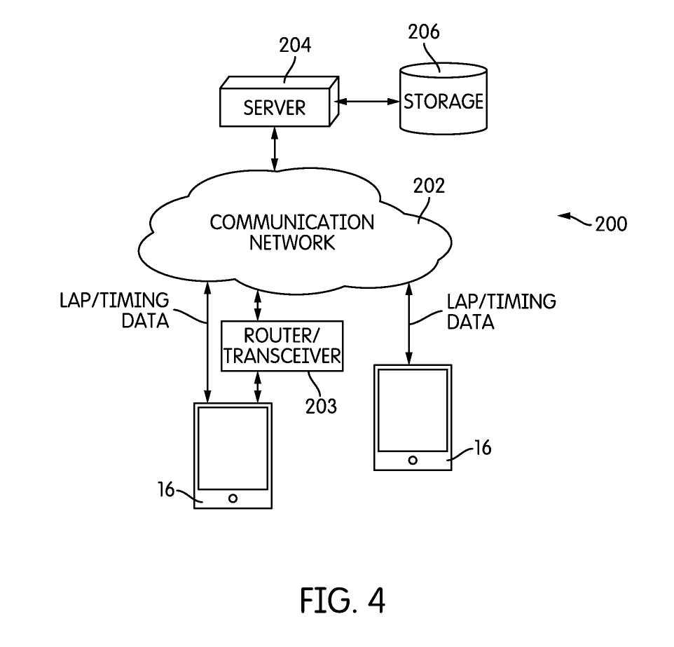

FIG. 4 is an illustration of a broader system, generally indicated at 200, that allows two or more swimmers 14, each using a system 16, to race against each other. As shown in FIG. 4, if the swimmers are in different pools, the multiple systems 16 communicate via a communication network 202 with a server 204. In practice, each swimmer 16 would have an account or a registered identifier with a service that operates the server 204. As lap timing data is acquired, it is transmitted from the originating system 16 to the server 204, which transmits it to the other system 16. The server 204 may also store the data in long-term storage 206. As those of skill in the art will recognize, any number of systems 16 may be placed in indirect communication this way using this kind of “cloud-based” approach, with a distant server 204 handling user authentication, recordkeeping, and transmission of real-time data from one system to another. Of course, if the swimmers 14 are local to one another, they may choose to connect their systems 16 directly using a local communication protocol like WiFi or Bluetooth, or by direct, wired connections, which may obviate the need for a server 204 in some cases.

While systems 16 may communicate directly with a communication network 202, as those of skill in the art will appreciate, they may also communicate through any number of conventional devices, including routers and transceivers 203 of various types. These devices 203 may provide a range of functions and services, including gateway services, routing, firewall functionality, signal amplification, and signal filtering. In some cases, a router, transceiver, or amplifier 203 may be placed poolside to capture signals from systems 16 that are placed underwater, since typical communication modalities may have shorter effective ranges when operating underwater.

The system 200 of FIG. 4—with one or more in-pool systems 16 connected to a server 204—may also be used in other contexts. For example, a single swimmer 14 may use the system 200 of FIG. 4 to store his or her own data without competing against other swimmers 14, and the server 204 may be used for more advanced analysis of the swimmer's performance. Swim performance data from the server 204 may also be published to other places, such as social networks. When multiple systems 16 are in a swimming pool 16, those systems 16 may communicate directly, using, e.g., radio frequency communication or ultrasound communication, so as to share and display data on multiple swimmers competing or practicing together simultaneously on all systems 16.

Once parameters are entered in task 104, method 100 of FIG. 3 continues with task 106 and task 108. In task 106, the swimmer 14 places the system 16 on the bottom or side of the pool 12, and then, in task 108, activates the sensor to begin gathering data. The order of these two tasks 106, 108 is not critical, and in some embodiments, the swimmer 14 may activate the sensor before placing the system 16 in or around the pool. A remote control unit, not shown in the drawings, may also be used to activate the system 16 once it has been placed.

For the remainder of this description, it will be assumed that the sensor used by method 100 is the camera 24, 26 of the system 16. However, as those of skill in the art will appreciate, aside from light, there are other characteristics that can be measured by the system 16 to achieve the goals of method 100. For example, the system 16 might measure incident water pressure (e.g., using an onboard accelerometer), sound (e.g., using an onboard microphone), or use a ranging technology like active sonar. When using other characteristics, like pressure or sound, to determine when a swimmer 14 has completed a lap, the basic problem is the same: identify the event amidst background noise.

Method 100 continues with task 110. In task 110, the system 16 captures a frame of data from the sensor. If the system 16 is using a camera 22, 24 as the sensor, this is equivalent to capturing a single exposure. Before taking a frame of data in task 110, it may be helpful if the software executing method 100 disables features like auto-exposure control, so that each frame of data is taken with the same shutter speed, aperture, and ISO settings. Auto-focus features may also be disabled, or, in the alternative, the image may be auto-focused once, once the system 16 is in the water and on the first iteration of task 110, and not after that. Alternatively, as will be described below in more detail, some cameras 22, 24 allow lower-level data, like luminance data, to be extracted without taking a full exposure, and in those cases, the data captured in task 110 may be only that data. Method 100 continues with task 112.

The result of task 110 is typically an image, although task 110 may gather other forms of raw data from the camera 22, 24 or other sensor without capturing an image. If the result of task 110 is an image, depending on the parameters set in task 104, the swimmer 14 may choose to save the image as an image or video for later analysis of the movements of the swimmer 14. Task 112 is a decision task. If parameters have been set to save images or video for later analysis (task 112:YES), control of method 100 passes to task 114, where the image or video frame is saved, before continuing to task 116. If the swimmer 14 has decided not to save images or video for later analysis (task 112:NO), method 100 bypasses task 114 and goes directly to task 116. Data collection for light, pressure, sound, sonar, and other methodologies may be at a rate independent of the frame rate of optional video recording.

In task 116, the acquired image or non-image data from the sensor, is transformed. While methods according to embodiments of the invention may use image analysis and machine vision techniques, like edge detection and blob analysis, to determine when a swimmer 14 has passed a defined point, these methods are computationally intensive and are not necessary in most embodiments. In order to simplify the computations and perform them more efficiently, in task 116, the system transforms the image gathered in task 110 so that only a portion of the data in the original image is used. Although the term “transform” is used in this description, in some embodiments, task 116 may involve using only a subset of the data available in the image or from the sensor, in other words, simply discarding unneeded data, rather than performing some type of transforming operation on it. The term should be construed broadly to refer to both types of operations. Although this description refers to “images,” the same principle holds for non-image forms of data.

One of the more effective ways of judging whether or not the swimmer 14 has passed over the point defined by the system 16 is measuring the light intensity using the camera 22, 24. For this reason, in some embodiments, a photodiode or array of photodiodes could be used instead of a camera 22, 24. If light intensity is the quantity being measured to determine whether or not the swimmer 14 has passed the defined point, then the objective of task 116, generally speaking, is to produce a single data point from the red, green, and blue (RGB) data provided by the camera 22, 24 sensor. This is done so as to maximize the observable difference between an event (i.e., the swimmer 14 passing by) and non-events (e.g., optical caustics and other lens effects created by the water and waves).

There are multiple methods by which this may be done, all of which are well known in the image and video arts. For example, task 116 may calculate a relative luminance value, which is a weighted linear sum of luminance coefficients for RGB, normalized to 1 or 100 for a reference white. Luma, the weighted sum of gamma-corrected RGB components, may also be used. Additionally, in some embodiments, a weighted sum of RGB components with custom weights for the red, green, and blue channels may be used. Unless otherwise indicated, the remainder of this description will assume that task 116 completes by producing a single luma value for each frame of data that is gathered, although method 100 could use lux or other units of measure.

Method 100 continues with task 118. Task 118 of FIG. 3 represents a variety of methods that may be used to determine when a swimmer 14 has passed over the defined point. As compared with the kinds of image-analysis methods described above, these methods work with the transformed data from the camera 22, 24 to differentiate signal from noise. In various embodiments, task 118 may use positive change (e.g., increase in incident light), negative change (e.g. decrease in incident light), or any other perceptible change to determine that an event has occurred.

As was described briefly above, while some portions of this description may assume that each data point processed in task 118 corresponds directly to an image or frame of video, that may not always be the case. Some devices 16 are capable of providing luminance data at a faster rate than that at which they capture images or video. In that case, method 100 may use the luminance data as provided by the system 16, decoupled from any particular image or frame of video. Doing this may allow the system 16 and method 100 to provide more precise lap timing by acquiring data faster.

As will be described below in greater detail, once task 118 executes to process a data point, method 100 continues with task 120, in which the data point is stored, transmitted, or both.

Along with storage of the data, method 100 also updates lap counters and timers in task 121 of method 100. A number of different types of counters and timers may be used in method 100. In the simplest embodiments, method 100 may simply count the elapsed time since the method began. However, method 100 may also implement a number of user-specifiable timers and lap counters in the course of defining a particular workout. Those timers and lap counters allow a swimmer to track an entire workout: they may specify sets of laps to be done in a particular stroke, followed by defined rest periods.

Following task 120, method 100 continues with task 122, in which it is determined whether method 100 should terminate. Method 100 may terminate when a swimmer 14 explicitly presses a control telling the system 16 to terminate method 100. Method 100 may also terminate when a preprogrammed swimming workout has been completed. In some cases, method 100 may terminate only if the user defined lap counters and timers indicate that the programmed workout, including all programmed rest periods between sets, has been completed.

If method 100 should terminate (task 122:YES), method 100 continues with task 124 and returns. If method 100 should not terminate (task 122:NO), control of method 100 returns to task 110 and another frame of data is acquired.

Method 100 of FIG. 3 and the description above provide an overview of the functions that are performed by the system 16 in separating signal from noise and determining when an event, such as a turn, has occurred. A deeper understanding of the nature of the noise inherent in various measures of an aqueous environment is helpful in understanding the precise functions performed by method 100 and other methods according to embodiments of the invention.

As those of skill in the art will appreciate, optical caustics are one of the primary sources of optical noise in a pool environment. These optical caustics are refractive effects created by wave peaks and troughs at or near the surface that concentrate and disperse light in particular patterns at the bottom of the pool. Splashes, bubbles, water flow, and other mechanical disturbances in the water also create noise.

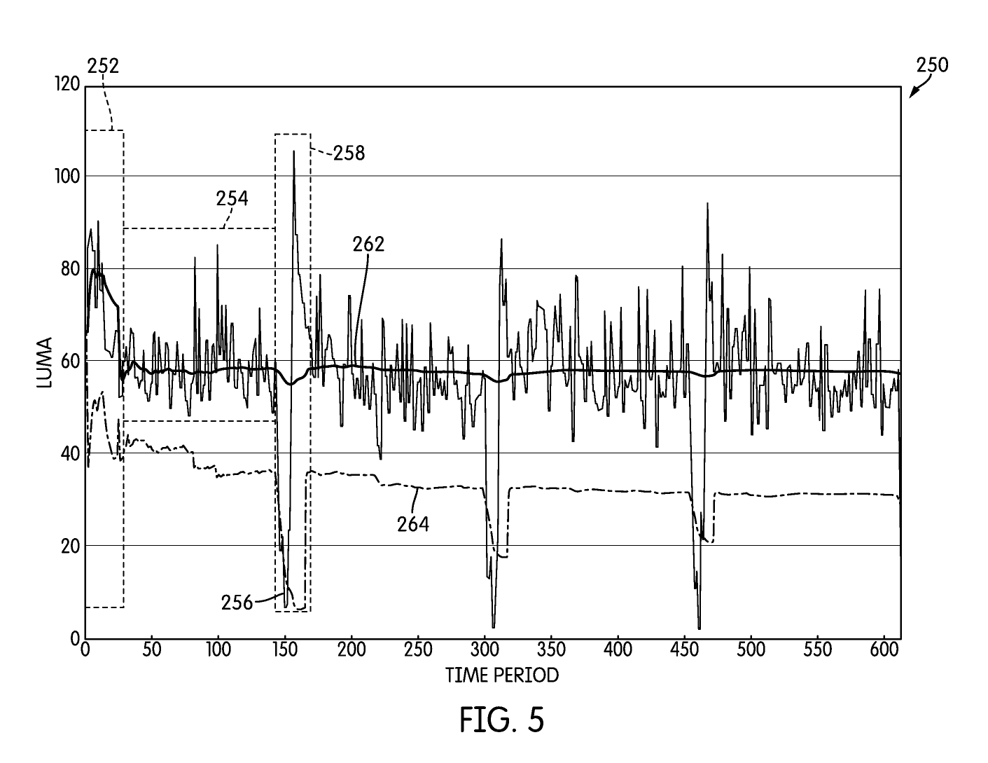

The magnitude and nature of the noise, as compared with an actual event to be detected, are illustrated in FIG. 5, a graph 250 showing data derived from images acquired by a camera 22, 24 positioned at the bottom of a pool 12 as a swimmer 14 swims laps in the pool. Each data point on the graph 250 is derived from a single luminance data value obtained using the camera 22, 24. As was described above, the acquisition of these data points was decoupled from the taking of images and video. In graph 250, the data was acquired at a rate of 10 Hz.

The X-axis of the graph represents time, while the Y-axis is in units of luma. More particularly, as was described above, the image data is first transformed from RGB into a light intensity value, in this case, luma. For convenience in computation and illustration, the luma data is then further manipulated. One useful way to treat the luma data is to establish a learned ambient mean for the luma data that is continuously but selectively updated as the data is acquired.

After the system 16 is first placed in the pool 12, or after the swimmer 14 begins to swim, there is a relatively long settledown period 252 while the water settles. After the settledown period 252, there is a relatively stable period 254 until the user makes a turn 256. The turn 256 is perceptible as a drop in light intensity that, in the illustrated case, amounts to a drop to a luma detection threshold value more than 3.5 standard deviations less than the learned ambient mean luma value. The detection threshold value may be determined a priori or be learned for each workout analytically. After the turn 256, there is another settledown period. (The settledown period and the duration of the turn are enclosed by box 258 in FIG. 5.) This pattern repeats with several more turns in the graph 250. The learned ambient mean 262 is shown in the graph, as is the threshold 264 used by the system 16 to determine whether a turn has occurred. The threshold 264 in this case is the standard deviation multiplied by a threshold criterion of 3.5. Because it is based on the standard deviation, a measure of the variability of the data, the threshold 264 changes along with the data.

As shown, as time progresses, the learned ambient mean 262 becomes increasingly steadier. In the graph 250, the drop in luma value for each turn is different, but each turn shows a drop of more than 3.5 standard deviations from the learned ambient mean. Each turn is accompanied by some short-term volatility; as those of skill in the art will appreciate, a turn has some finite duration, and as long as the turn is in progress, the data will exhibit some volatility.

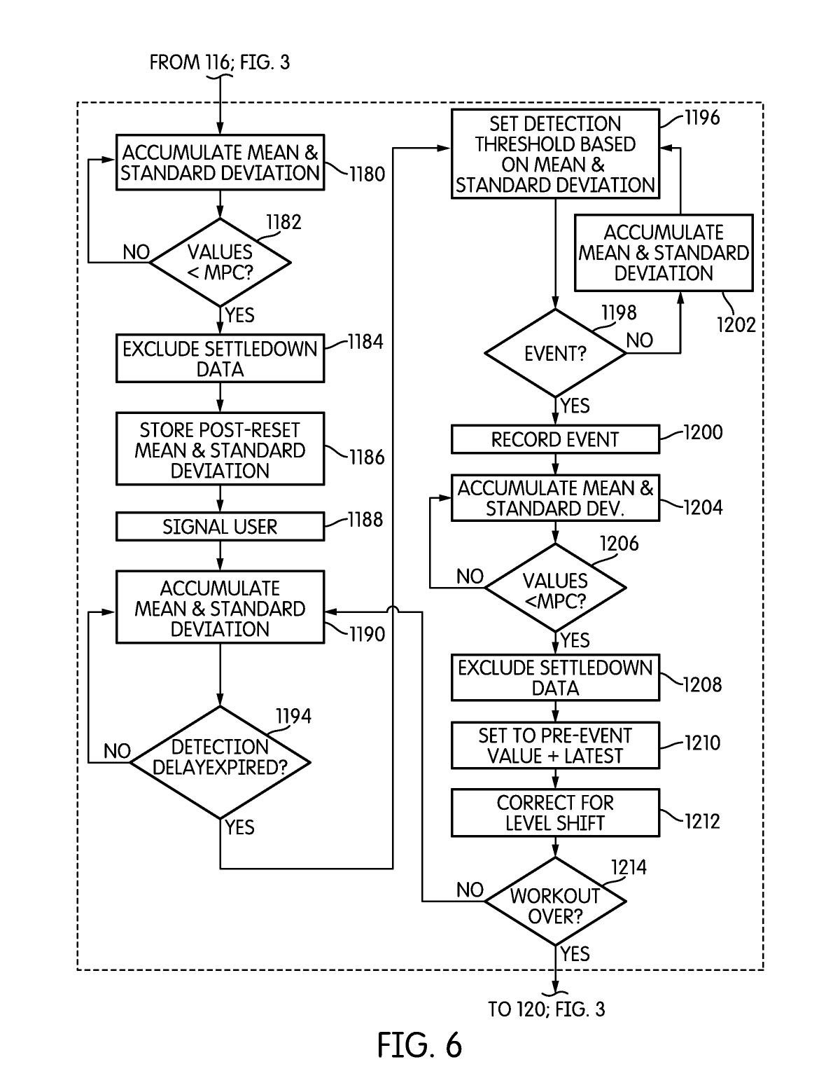

FIG. 6 is a more detailed flow diagram illustrating one advantageous way of performing the functions of task 118 of method 100 in FIG. 3. In the version illustrated in FIG. 3, task 118 begins once a frame of data has been gathered and transformed in earlier tasks of method 100. For ease of illustration and explanation, the embodiment of task 118 shown in FIG. 6 duplicates some functions ascribed to other tasks of method 100 and presents task 118 as being more self-contained. In particular, FIG. 6 includes some data acquisition sub-tasks in task 118; in a real-world implementation, acquisition of data points may be occurring continuously while the data analysis of task 118 occurs in parallel.

As task 118 begins for the first time, the system 16 has presumably just been placed in the swimming pool 12. When the system 16 has just been placed in the swimming pool 12, the recent disturbance to the water creates additional noise and may make the data too unstable to be useable in calculations. Sub-tasks 1180-1188 detail the procedure used to perform a settledown test—i.e., determine when the water is in a settledown period and thus too unstable to be used for valid detection.

More specifically, task 118 begins in sub-task 1180 by using a point of data gathered and transformed in tasks 110-116 to calculate statistics describing the ambient conditions, so that “baseline” or “benchmark” information can later be used as a basis for comparison to detect turns and other events. In typical embodiments, the calculated statistics will be mean and standard deviation values, although any useful statistics may be calculated. These calculated mean and standard deviation values may be referred to in portions of this description as a “learned ambient mean” and a “learned ambient standard deviation” because, as will be described below, they are continuously but selectively updated using new data points as they are acquired and thus reflect the ambient conditions in the swimming pool 12. In a typical implementation, the system 16 would keep and continuously update intermediates for the calculated statistics, so that the statistics can be rapidly calculated. For example, if a learned ambient mean and a learned ambient standard deviation are the calculated statistics, a running sum of the accumulated ambient data points (e.g., luma values) and a count of the number of accumulated ambient data points would be kept readily accessible in memory for the learned ambient mean calculation. For the learned ambient standard deviation, a running sum of the squared differences would be kept in memory. Task 118 continues with sub-task 1182.

In sub-task 1182, the new learned ambient mean and standard deviation values calculated in sub-task 1180 are compared with the last learned ambient mean and standard deviation values that were calculated. If the change between the most recent learned ambient mean and standard deviation values and previously calculated learned ambient mean and standard deviation values is too large, it indicates that the data is too unstable to be used for event detection and that the water is still in a settledown period. (As those of skill in the art will appreciate, as data accumulates and the mean and standard deviation are thus based on more and more data points, it becomes more and more unlikely that a single new data point will change the value of the mean and standard deviation much unless that data point represents a relatively large change in value over previous data points, although the mean is more stable than the standard deviation.) In order to define how much change is too much, task 118 uses a maximum proportional change (MPC) value to define the maximum level of change that is permitted in the mean and standard deviation. An MPC value would typically be expressed as a percentage, and may be, e.g., 1-5%.

The actual MPCs that are used in sub-task 1182 can be determined experimentally by gathering data like that in the graph 250 of FIG. 5 and analyzing it. Typically, the MPC value would be set as a constant, and would not vary during a single execution of task 118 and method 100. In one embodiment, for example, the MPC value may be 2%; in other words, a data point can be used in calculations, and indicates that the pool 12 is no longer in a settledown period, if that new data point, when used to calculate mean and standard deviation, creates a change in mean and standard deviation of less than 2% compared with a prior calculated mean and standard deviation. The change may be positive or negative, and in many cases, absolute values may be used in the calculations and comparison of sub-task 1182, because the magnitude of the change is more important than its direction (positive or negative).

In the simplest cases, the comparison relies on only the current data point. However, more complex methods involving multiple points of data may be used in sub-task 1182. For example, a moving four-point window may be used; that is, the system may take the average of the last four data points, take the average of a set of four data points before that, determine the percentage change between those two sets of points, and compare that percentage change, or its absolute value, to an MPC threshold.

With respect to sub-task 1182, if the accumulated mean and standard deviation values are greater than the MPCs (sub-task 1182:NO), task 118 excludes the new data point from use in calculations, takes a new data point, and repeats the test of sub-task 1182, thereby extending the settledown period. As those of skill in the art will appreciate, if sub-tasks 1180 and 1182 make the initial settledown period 252 unacceptably long, the MPCs can be modified.

If the mean and standard deviation values are less than the MPCs (sub-task 1182:YES), task 118 continues with sub-task 1184, terminates the settledown period and resets. Task 118 then continues with task 1186, in which post-reset mean and standard deviation values are generated and stored. At that point, task 118 continues with sub-task 1188, and the user is signaled to begin swimming. The user may, for example, be notified to start swimming with a flashing, colored screen and a countdown. Alternatively, the swimmer may initiate countdown manually with analysis of the water starting when the countdown completes. Method 100 may ignore detection of the swimmer's starting pass over the system 16.

Sub-tasks 1180-1188 create a process whereby data points are continuously taken and recorded, but are only selectively used for lap-timing and event detection, and only after the stability and nature of the data is checked. Once the initial settledown period 252 has been detected and dispensed with, task 118 returns to accumulating data and calculating a learned ambient mean and standard deviation in sub-task 1190. This may be done in the same way as in sub-task 1180. When task 118 begins sub-task 1190, it has begun checking for events.

By the conclusion of sub-task 1190, the system 16 is accumulating data and calculating the learned ambient mean and standard deviation that describe the ambient conditions and are used as a baseline against which detection occurs. These are the first steps in detecting an event. However, it is not necessary to use the accumulated statistics for event detection immediately, because it takes some non-zero amount of time for the swimmer 14 to complete a lap. For that reason, attempting to detect the end of a lap immediately after a settledown period finishes, before anyone could reasonably finish a lap, while certainly possible, increases the risk of false positives, e.g., caused by someone crossing the swimmer's lane during the time period in which it would not have been possible for the swimmer 14 to approach the system 16 at the completion of a lap, and tends to waste computational time and power.

Thus, task 118 implements a delay before event detection takes place, as shown in sub-task 1194. In order to implement a reasonable and realistic period of delay before event detection, the system 16 may include a set value or a look-up table defining the detection delay for the particular circumstances. In many cases, that delay may be tailored to the age and gender of the swimmer 14, and to any other parameters entered in task 104 of method 100. For example, the system 16 may store data on the world's fastest times for a single lap by age, gender, and stroke. The world's fastest time for the age, gender, and stroke of the swimmer 14 could then be used to determine the extent of the detection delay in sub-task 1194. If a swimmer-specific delay is not used, the world's fastest freestyle time, irrespective of age and gender, may be used as a default.

With respect to FIG. 6, if the detection delay has not expired (sub-task 1194:NO), control of task 118 returns to task 1190 and another data point is accumulated. If the detection delay has expired (sub-task 1194:YES), task 118 continues with sub-task 1196.

By the time detection operations begin, task 118 has created a learned ambient mean and standard deviation that change with the ambient conditions. In order to detect an event, task 118 must create a threshold that is responsive to the ambient conditions, excludes variability that is irrelevant to detection, and provides reliable detection without false positives or false negatives.

For example, in one embodiment, the reliability of the detection method may be equal to or surpass 1 in 4,000: one false detection for every 4,000 events detected.

To do that, sub-task 1196 calculates and establishes a detection threshold based on the learned ambient mean and the standard deviation. The present inventor has found that when one excludes data points gathered during settledown periods, the remaining data follows a Gaussian distribution. Given that distribution and well-known statistical methods, it is a straightforward exercise to calculate a multiple of the learned ambient standard deviation beyond which it is highly probable that any detected value indicates that the swimmer 12 has passed over the system 16. The fact that the transformed data follows a Gaussian distribution also enhances the validity of calibration of the statistical techniques.

In the conditions of a lap swimming pool, for example, the threshold may be between 3 and 4 learned ambient standard deviations from the mean, for example, about 3.5 standard deviations beyond the mean. In this example, whether the threshold itself is 3.5 standard deviations beyond the mean or −3.5 deviations beyond the mean depends on whether positive change or negative change is being used for detection. The threshold may be chosen, for example, so that the probability of a false detection is 1 in 4,000 or greater.

In determining which data points to use in calculating the mean and using it to set a threshold, it can be very helpful to consider only the variability that is relevant to the detection, and to simply ignore other, irrelevant variability. As a result of optical caustics, waves, bubbles, and other factors, in a typical underwater environment during a stable period between turns, there may be spikes in luma that are up to two standard deviations greater than the learned ambient mean and up to one standard deviation less than the learned ambient mean. However, where only drops in luminance are used for detection purposes (i.e., negative change), positive variation is irrelevant to detection. Therefore, in many embodiments, it is helpful to exclude positive variation, as shown in the transformed luma data line 272. Simply put, if negative change is being used to detect events, task 118 may simply ignore positive changes. Similarly, if positive change is being used to detect events, task 118 may simply ignore negative changes. This may be done either when data points are accumulated in sub-tasks 1180 and 1190, or later in sub-task 1196.

To eliminate variability that is irrelevant to detection, the system 16 may take the difference or delta between a current data point and the previous data point. In a situation where negative change is being used to detect events, if the difference or delta is less than zero, the data point is used for calculations. If the delta or difference is greater than zero, the new data point is discarded for calculation purposes and the previous data point is simply copied into the new data point. If positive change is used for detection, negative deltas or differences would indicate that a data point should not be used for calculation. Screening out variability that is irrelevant to detection prevents the detection threshold, which is based on the mean and standard deviation, from drifting over time in response to irrelevant spikes in the data. Such drift would make detection of events more restrictive. Moreover, if a data point is not used for calculation, copying the last value, rather than inserting an arbitrary value like zero, prevents the introduction of bias in ambient conditions.

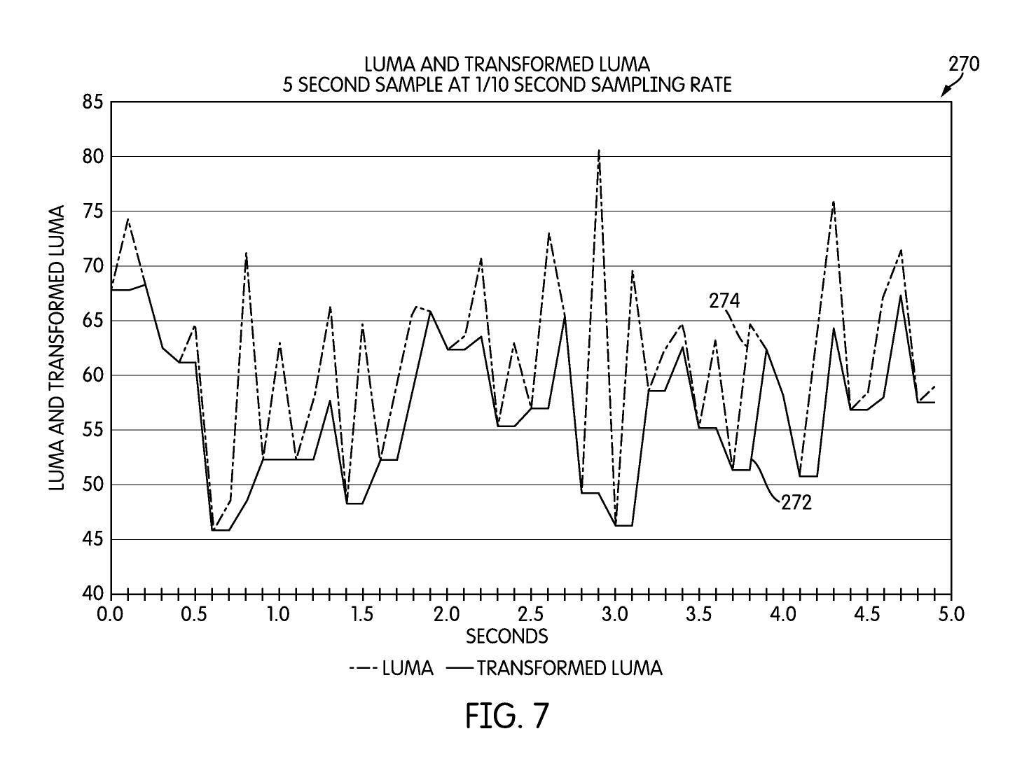

These concepts are shown in FIG. 7, a graph 270, a five-second sample of data taken at a rate of 10 Hz. The transformed luma data 272 is identical to the data shown and used in graph 250 of FIG. 5. The original luma data 274 is also shown. Additionally, Table 1 below presents selected original and transformed data points from graph 270 for a two-second slice of time.

TABLE 1
Original and Transformed Luma Data Values from FIG. 7

| Time | | Transformed |
|---|---|---|
| (s) | Luma | Luma |
| 0.0 | 67.816 | 67.816 |
| 0.1 | 74.159 | 67.816 |
| 0.2 | 68.212 | 68.212 |
| 0.3 | 62.567 | 62.567 |
| 0.4 | 61.203 | 61.203 |
| 0.5 | 64.637 | 61.203 |
| 0.6 | 45.862 | 45.862 |
| 0.7 | 48.298 | 45.862 |
| 0.8 | 71.108 | 48.298 |
| 0.9 | 52.274 | 52.274 |
| 1.0 | 63.012 | 52.274 |
| 1.1 | 52.307 | 52.307 |
| 1.2 | 57.668 | 52.307 |
| 1.3 | 66.415 | 57.668 |
| 1.4 | 48.278 | 48.278 |
| 1.5 | 64.747 | 48.278 |
| 1.6 | 52.218 | 52.218 |
| 1.7 | 59.194 | 52.218 |
| 1.8 | 66.275 | 59.194 |
| 1.9 | 65.742 | 65.742 |
| 2.0 | 62.303 | 62.303 |

As can be appreciated from FIG. 7 and Table 1, whenever a luma value shows a positive change relative to the last value, it is discarded and the last value is substituted for the new value.

Once the detection threshold is set in sub-task 1196, task 118 continues with sub-task 1198, a decision task. If, after a data point is accumulated, the learned ambient mean is updated, and the threshold is calculated based on the learned ambient mean and standard deviation, a data value exceeds the threshold, that is a sign that an event has occurred. In that case (task 1198:YES), task 118 continues with sub-task 1200, where the event is recorded. If there is no event (sub-task 1198:NO), task 118 continues with sub-task 1202, another data point is accumulated, the mean and standard deviation are calculated, and task 118 then returns to sub-task 1196.

Recording the event in sub-task 1200 may involve any number of application specific tasks. Depending on the situation, the system 16 would typically increment the lap count, and may also start and stop lap timers as necessary. Other functions may be triggered when an event is detected, including giving specific visual, auditory, or video feedback to the swimmer 14. For example, the background color of the screen 26 may change depending on whether the swimmer 14 is ahead of or behind a predefined pace.

Additionally, “recording” the fact that an event has occurred in sub-task 1200 may also include timing the event itself. No event involving human beings is instantaneous; all events have some duration to them. For performance swimmers, the duration of a turn can be important and a movement on which a great deal of time and energy is spent to maximize efficiency. Thus, a record of the durations of a swimmer's turns can be very valuable. Turn duration may be measured, for example, by recording the duration of statistically significant detections.

Once an event has occurred, the water around the system 16 may be in a settledown period. Thus, with respect to the flow diagram of FIG. 6, once the event has been recorded, task 118 continues with sub-task 1204 and implements a settledown test. Similar to sub-tasks 1180 and 1202, sub-task 1204 begins accumulating data values for the mean and standard deviation. In sub-task 1206, if those values are less than defined MPC values (sub-task 1206:YES), the settledown period is over and task 118 continues with sub-task 1208. If the values are greater than the defined MPC values (sub-task 1206:NO), task 118 returns to sub-task 1204 and continues accumulating mean and standard deviation values.

In sub-task 1208, the data accumulated during the settledown period is excluded from the mean and standard deviation calculations, and in sub-task 1210, the values are re-set to the pre-event values plus the latest good data value.

Following sub-task 1210, task 118 continues with sub-task 1212. As the swimmer 14 continues with his or her workout plan, it is possible that with the passage of time, ambient conditions may change. For that reason, once an event occurs, task 118 stores the learned ambient mean and standard deviation for the previous lap or small number of laps. In sub-task 1212, task 118 determines the difference between the ambient mean and standard deviation for two consecutive periods. If that difference is above a threshold, task 118 will reset the learned ambient mean and standard deviation to that for the preceding lap or set of laps, and begin accumulating ambient condition data from there.

Once sub-task 1212 is complete, task 118 continues with sub-task 1214, a decision task. In sub-task 1214, if the programmed workout is over (sub-task 1214:YES), task 118 terminates. If the programmed workout or set is not over (sub-task 1214:NO), task 118 returns to sub-task 1190 and continues to accumulate data points and calculate the mean and standard deviation.

The frequency with which method 100 and task 118 are executed will depend on a number of factors, including the computing power of the system 16, the desired level of measurement accuracy, and the rate at which the camera 24, 26 or other sensor can gather data. If full exposures are used as the source of the data for task 118, 3-4 frames per second may be sufficient to accomplish the objectives of the method. Of course, method 100 and task 118 may be executed at whatever frequency the system 16 is capable of. If the camera 24, 26 is capable of providing luminance data separately from and faster than images, as was described briefly above, method 100 may use that capability to execute at higher frequency. The swimmer may also be given the opportunity to set the frequency, which determines the precision of timing. Many performance swimmers may desire one-tenth or even one one-hundredth of a second precision, while many casual non-performance swimmers may be happy with one second or even less precision.

As those of skill in the art will appreciate, any number of techniques may be used to process the data in place of the techniques described with respect to task 118. Essentially any technique that can be used to process a time series may be used in methods according to embodiments of the invention. Examples include Kalman filtering of the sensor output; autoregressive integrated moving average (ARIMA) modeling; and approximate entropy (ApEn) techniques, among many others.

The difficulty with many standard, unmodified data analysis techniques is that they analyze all of the data, including unstable and irrelevant periods and detections. This biases detections, a bias that increases over time. Many of these techniques require much larger data samples. Additionally, many of the standard techniques for evaluating time series of necessity must compute using the entire time series at once, instead of accumulatively, one data point at a time. Primarily for this reason, some techniques are so computationally intensive that they may not be able to operate in real time with only the computing power available on the system 16.

By contrast, the method 100 described above, and other methods according to embodiments of the invention, can operate in real time on a system 16 with limited processing power. In part, this is because the computations performed on the data for calculations of mean and standard deviation are elementary in nature; as was described above, the system 16 stores intermediate values, like a running sum of the relevant data values, the number of values in the selected data set, and the sum of the squared differences for calculations of the mean and standard deviation; the methods restrict event detection to periods of time in which it is actually possible that an event could occur; and the methods exclude variability that is irrelevant to detection of the event (e.g., positive light spikes when detection is based on a drop in incident light or negative pressure when detection is based on increase in pressure). Additionally, the use of a learned ambient mean and standard deviation, and periodically checking the level of the mean and the amount of variation (i.e., the standard deviation) for secular shifts (i.e., large and persistent shifts) as time progresses, allows methods according to embodiments of the inventions to adapt to changing ambient conditions.

If the swimmer 14 requires more detailed analysis than can be provided in real time, as was described above, that analysis is available after-the-fact using data stored either on the system 16, on another computer, or in remote storage 206 using a server 204. In addition to the data used to detect laps and turns, stored video, if any, may be stored and evaluated after the fact. In some cases, manual frame-by-frame video analysis or automatic image analysis techniques may be used to evaluate the swimmer's biomechanics.

Although traditional regression and autocorrelation-based methods, like ARIMA intervention analysis, may be unsuitable for real-time use in detecting turns and timing laps, those methods may be used in conjunction with the present methods, particularly in post-analysis. As processing speeds continue to improve in modern computing devices, traditional regression and autocorrelation methods may become more feasible and useful.

In addition to analysis of the swimmer's own times and performance, embodiments of the invention can provide the swimmer 14 with competitive prompting and comparative performance evaluation. As was described above, the system 16 can store average or record performance data, like the world's fastest times broken down by age, gender, and stroke, and uses that data in the course of task 118 to perform event detection only when an event would be physically possible. Average performance data, record-setting performance data, and performance data normalized by age, gender, and other factors, can also be used in other ways in method 100.

In some embodiments, the benchmark performance data may be used to give the swimmer 14 the ability to “compete” against the swim times and other performance characteristics set by another swimmer. For example, a swimmer 14 might be given the option to swim against the times and records set by Michael Phelps, the noted Olympic swimmer, or, if the system 16 is used for running, to run against the times and records set by Sonia O'Sullivan, of 2 kilometer fame. Not all of the data stored need pertain to champions; in some cases, a user might compete against a record or goal set by the user or by another user, including in situations when that other user is not available to compete in real time.

If the swimmer chooses to compete against stored records or goals, at any point in time, as the system 16 displays the lap time and total elapsed time for the swimmer 14, it may also display information on where the benchmark swimmer was or would be at that time in the swim, and may include measures of position relative to a goal or to another swimmer. It should be understood that while the system 16 may in some embodiments store a large amount of data describing every phase of the swim of a particular benchmark swimmer, the system 16 may instead provide benchmarking information by extrapolating performance factors from a single data point. For example, from an overall swim interval time, the system 16 may extract individual lap times.

As described above, one advantage of the system 16 is that in typical implementations, the swimmer 14 is unmodified—he or she need not wear a reflector, a communication device, or anything else that could potentially be an inconvenience or could hinder performance. However, there are certain embodiments, and certain specific conditions, in which it may be useful to wear certain sensors or position indicators.

One case in which an accessory may be worn is if the swimmer 14 chooses to record his or her vital signs during his or her workout. In that case, he or she may wear a sensor to record those vital signs. For example, a vital sign sensor may be worn inside the swim cap at or near the temple to establish heart rate and other vital signs. That sensor may communicate with the system 16 by a wireless communication protocol in a known manner, and the system 16 would generally synchronize the incoming physiological data with the event data. Any kind of vital sign sensor may be worn, and if not worn at the temple, a sensor may be worn at the wrist or in any other place. When a vital sign sensor is used, data from the sensor may be displayed on the screen 26 of the system 16 as the swimmer 14 passes over it.

Additionally, the above description assumes that there is one swimmer 14 per lane, and thus, if a swimmer 14 passes over the system 16, it will be the swimmer 14 that the system 16 is tracking and timing. If there are multiple swimmers 14 in the same lane or otherwise in proximity to one another, the swimmer 14 working with the system 16 may wear a reflector or another type of device that will produce a distinct optical signature when viewed by the camera 22, 24. Multiple reflectors or light sources may each reflect or emit a different portion of the spectrum. Other methods, devices, and algorithms for tracking and timing multiple swimmers will be described in more detail below.

Of course, as those of skill in the art will realize, it may not be necessary to use reflectors or markers, even when there are multiple swimmers in the same lane. Instead, the swimmer 14 setting up the system 16 may be asked in task 104 of method 100 whether there are to be multiple swimmers 14 per lane, how many swimmers 14 there will be, and their start order. In that case, the event detection delay of task 118 of method 100 (sub-task 1182) may be relaxed, or multiple, separate delays may be instituted. System 16 and its detection methods can then assume which swimmer 14 is which because, e.g., the first event will be assumed to belong to the first swimmer 14 to start, and the second event will be assumed to belong to the second swimmer 14.

### Active Detection Techniques and Hardware

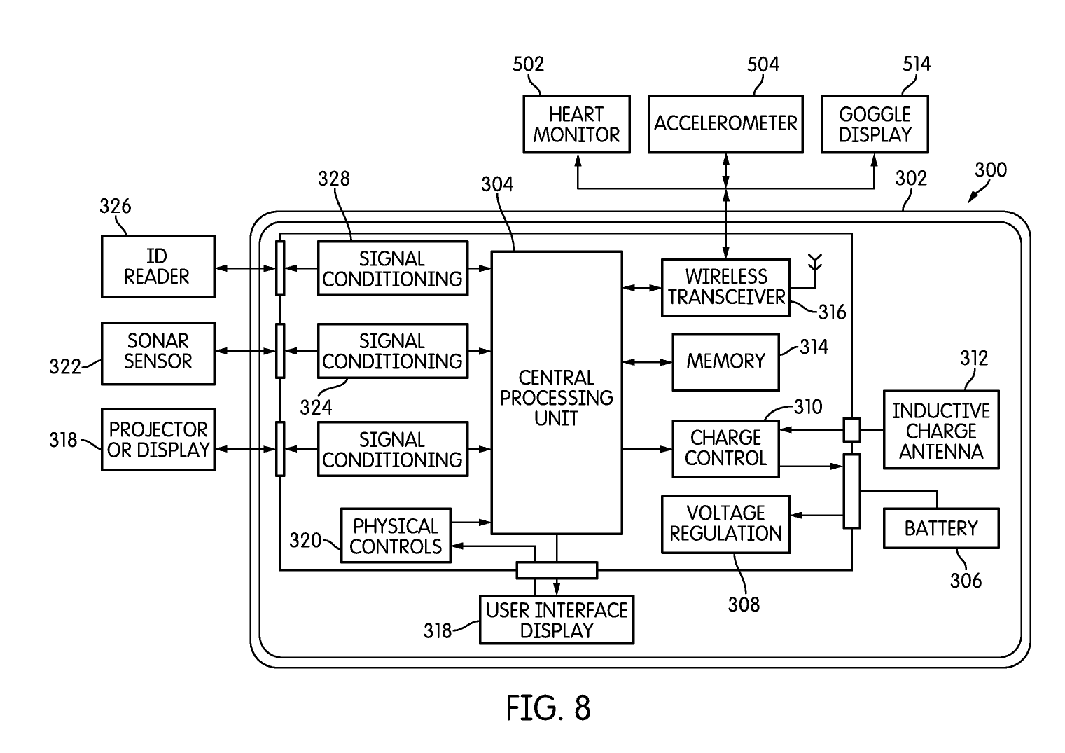

In much of the description above, the system 16 was assumed to be a commercial computing device, e.g., a tablet computer or cell phone. In some cases, however, custom-built hardware can provide more tailored capabilities. FIG. 8 is a schematic diagram of a system, generally indicated at 300, that includes hardware specifically tailored for some of the tasks set forth in this description.

Within a case 302 that would be waterproof if system 300 is intended for swim lap detection and timing, system 300 includes a number of components. A central processing unit 304 provides the computational power of system 300. Depending on the embodiment, the central processing unit 304 may be a microcontroller, a microprocessor, an application-specific integrated circuit, or any other type of integrated circuit or device capable of performing the described functions. In some embodiments, the central processing unit 304 may be a part of a so-called “system on a chip” that includes a microprocessor and other components in a single, integrated package.

System 300 has a battery 306 that provides power to the other components, through a voltage regulator 308, for example. (Other types of “power conditioning” circuits or devices may be provided as well, and power may be distributed to the other components in a variety of different ways.) The battery (or batteries) 306 would typically be a rechargeable battery, such as a lithium ion battery, and a charge control system 310 that charges and maintains the performance of the battery 306. In a typical portable computer, power to charge a battery 306 is supplied by cable to an appropriate port, and such a power port (or power-and-data port) may be provided in system 300. However, in the illustrated embodiment, system 300 is adapted to be charged inductively, and to that end, includes an inductive charge antenna 312.

Computationally, system 300 includes memory 314 and at least one wireless communication transceiver 316. The wireless communication transceiver 316 may be, for example, a BLUETOOTH® wireless transceiver, although other communication protocols may be used, including IEEE 802.11a/b/g/n WiFi. In order to transmit from below the water, it may be necessary or desirable for system 300 to include a physical antenna that is not contained within the case 302, extends above the water, and is connected to the wireless transceiver 316 via a cable. Alternatively or additionally, system 300 may include a physical input/output port to connect by cable or other physical connector to a transceiver located out of the water.

In FIG. 8, the components are shown as being directly connected to the central processing unit 304, but may instead be connected to the central processing unit 304 via a bus (not shown in FIG. 8). With respect to memory 314, system 300 may include random access memory (RAM), read-only memory (ROM), programmable and erasable memory, etc. In a typical configuration, system 300 would include at least flash memory, or another type of memory that provides equivalent function.

The central processing unit 304 also interfaces with, and takes input from, a user display or displays 318 and from any physical controls 320 that may be installed on system 300. The display screen and interface 318 may be a touch screen in many embodiments, although other types of interfaces may be used.

System 300 also includes a number of components intended for the specific sensing tasks set forth in this description. In much of the above description, the primary sensor used to determine whether or not a swimmer had passed a defined point is an optical camera. However, as was described briefly above, other techniques may be used for detection, and system 300 uses a detection method based on sound—essentially a simplified sonar system. The sensor 322 may be, for example, an ultrasonic transducer, and depending on its functional requirements, it may lie within the case 302 or outside of it. The sensor 322 communicates with the central processing unit 304 through signal conditioning circuits 324. The sensor 322 may include or be surrounded by a cone or another type of barrier or lens that focuses the energy along a particular path or in a particular area, so as to restrict the field of view or detection volume of system 300 as appropriate.

As will be described below in more detail, system 300 is also adapted to use radio-frequency identification (RFID) technologies, or other types of identifying technologies, to distinguish between multiple swimmers or competitors within its detection field, and an identity reader 326 for identifying individual swimmers, such as an RFID reader, would typically also be in communication with the central processing unit 304 through its own signal conditioning circuits 328. If system 300 is configured to use another type of identifying technology, such as ultrasound transponders, a different type of reader or transceiver may be used in place of the RFID reader 326.

In the description above, it is generally assumed that the system 16 uses its own display 26 to display data. However, in some embodiments, system 300 may include or be connected to a projector or laser writer 328 capable of projecting lap, timing, and other information on the sides or bottom of a pool 12. For example, a projector or laser writer 328 may display images, vital signs, projected calorie consumption, or any other information necessary, desirable, or helpful to a swimmer 14.

Additionally, as will be described below in more detail, using system 300, it is possible to outfit a swimmer 14 with a number of sensors and peripherals to provide more information during swimming. If system 300 is intended for use with peripherals, those peripherals, such as the heart monitor 502, accelerometer 504, and goggle display 514 illustrated in FIG. 8, may communicate with system 300 via the wireless transceiver 316 using radio frequency communication, or they may be adapted to communicate underwater via ultrasonic communication, in which case the sonar sensor 322, or a specialized sonic transceiver, would be used to communicate with them.

While FIG. 8 illustrates that the components of system 300 are largely within the same unitary case 302, that may differ from embodiment to embodiment. While a single, unitary piece may be convenient, system 300 may be divided into multiple parts, particularly if a projector or laser writer 318 is used, or if necessary to place a transceiver outside of the water for communication purposes, to give but a few examples.

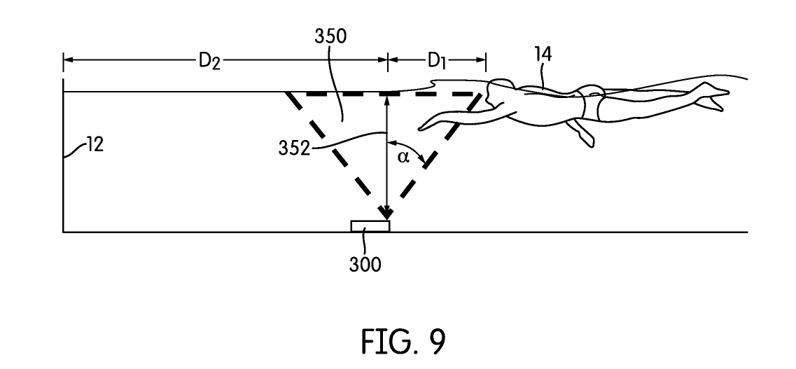

FIG. 9 is an illustration of a system 300 positioned on the bottom of a swimming pool 12. As shown in FIG. 9, a swimmer 14 is swimming toward system 300 in the pool 12. As with the embodiment described above, when the swimmer 14 passes a defined point, the number of laps are incremented, times or other pieces of information are displayed, and other tasks are performed. However, with system 300, the swimmer 14 may have additional flexibility in defining exactly where the defined point is located.

With system 300, the sonar sensor 322 defines a detection volume 350—a volume of space (in this case, water) in which a swimmer 14 can be detected and tracked. That detection volume 350 would typically be in the shape of a cone, as it is in FIG. 9, although the two-dimensional view of FIG. 9 reduces that volume 350 to a plane. In the illustration of FIG. 9, the defined point is actually a defined line or plane 352 that extends vertically upward from system 300. However, the defined point or plane 352 may be anywhere within the detection volume 350. Additionally, while some of this description may focus on the tracking of a single swimmer 14 entering the detection volume 350, in many cases, system 300 may be adapted to track multiple swimmers 14, regardless of whether they are in the same lane or different lanes, so long as they enter the detection volume 350. As was described briefly above, a cone or other elements may be used to focus or spread the detection volume 350 as necessary or desired to accommodate multiple swimmers 14 or to extend the detection volume 350 over a volume that a single swimmer 14 is expected to cross.

With the arrangement of FIG. 9, system 300 tracks a swimmer 14 as he or she enters the detection volume 350. The sonar sensor 322 provides bearing and distance information. With a detected distance to the swimmer and an angle, it is generally a simple exercise in trigonometry to calculate the horizontal distance D₁ of a swimmer 14 relative to the defined line or plane 352.

System 300 may be set to trigger when the angle, α, reaches a defined trigger angle. Alternatively, system 300 may use the angle α and either the depth or a detected distance to calculate a horizontal distance to the defined line or plane 352. When that horizontal distance equals zero, the defined line or plane 352 has been reached. Many variations on this theme are possible, and the calculations may be performed many different ways.

It can be useful in these kinds of trigonometric calculations to know and use the depth at which system 300 is placed at the bottom of the swimming pool 12. Thus, in some embodiments, system 300 can be configured to allow the swimmer 14 to sound the bottom of the swimming pool 12 to determine its depth before swimming. In that case, the swimmer 14 would place system 300 just under the water over its desired placement location and cause it to send ultrasound, laser, or other energetic pulses toward the bottom so as to sense and calculate a depth.

In the illustration of FIG. 9, system 300 is a distance D₂ away from the sidewall of the swimming pool 12 and the defined line or plane 352 marking the start and end of laps is a line or plane that extends vertically upward from system 300—i.e., it does not coincide with the sidewall, and a lap will be counted before the swimmer 14 reaches the sidewall. That may be perfectly satisfactory for some swimmers 14. However, other swimmers will want the defined line or plane 352 to coincide with the sidewall 12. In that case, the distance between system 300 and the sidewall, marked as D₂ in FIG. 9, can be readily determined or calculated, by sounding, direct entry of a known distance, or trigonometric calculation. If the detection volume 350 extends to the sidewall of the swimming pool 12, the time when the swimmer 14 reaches that point can be directly measured. If not, the time when the swimmer 14 reaches the sidewall can be estimated by using, e.g., the swimmer's average velocity during a lap and the known distance. Of course, a swimmer 14 may be prompted or warned if system 300 is too far away from a sidewall or another intended defined line or plane 352 to measure directly when the swimmer 14 crosses it.

As the description above indicates, when the defined line or plane 352 is reached, the lap count and times are generally updated. (See, e.g., sub-task 1200 of FIG. 4.) However, with system 300, that event may also be a trigger for other functions or changes. For example, the swimmer 14 may elect to see different data displayed for different laps, in which case, reaching a defined line or plane 352 may act as a trigger for changing the information that is displayed. The swimmer 14 may also elect to see different information when traveling toward system 300 than when traveling away from the wall after making a turn, in which case, a turn or delay may act as a trigger for changing the information that is displayed. After a time, or when the swimmer 14 is assumed or found to have left the detection volume, the display may return to its previous state. The swimmer may also elect to see the same information twice, once when approaching the wall and again when leaving it.

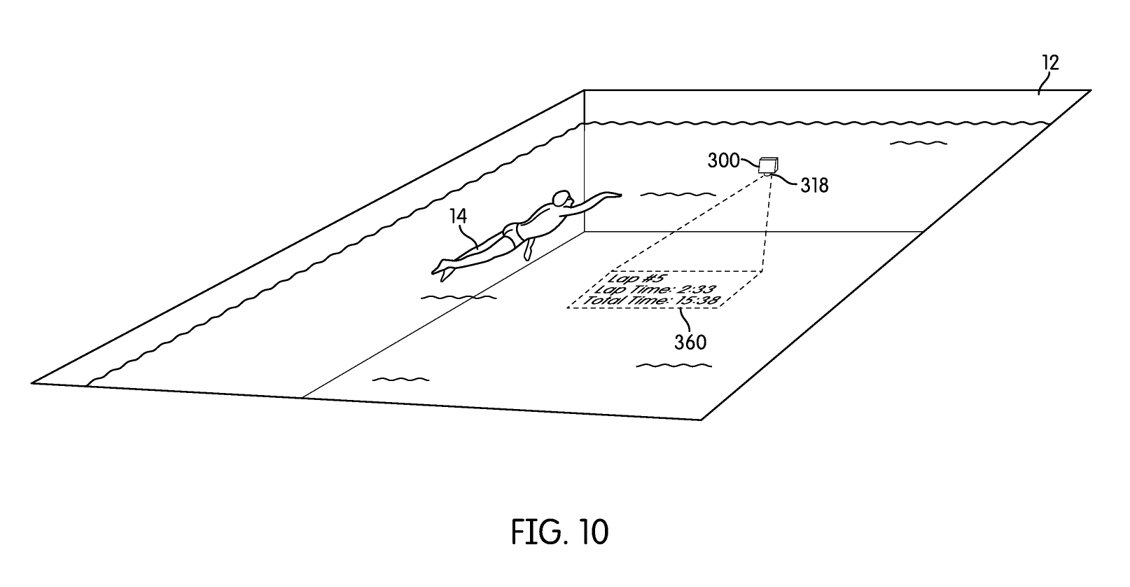

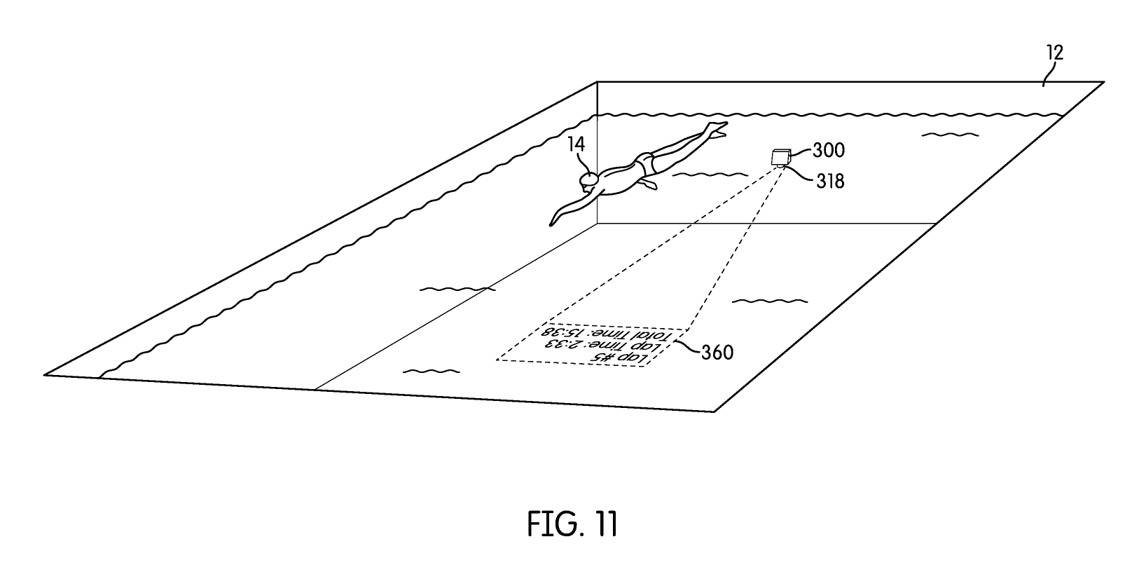

As one example, FIG. 10 is a perspective view of a swimming pool 12 with system 300 installed on a vertical sidewall. Whereas system 16 displays data exclusively on a display 26, system 300 may use a projector, a laser writer, or any other technology that can display data on an external surface. That projector 318 may display data in color or monochrome, depending on the particular embodiment. As shown in FIG. 10, the projector 318 displays data on the bottom of the swimming pool 12, some distance out from the sidewall. The wording and numbers face the incoming swimmer 14 in the illustration of FIG. 10, but after the swimmer 14 makes a turn, the data displayed may rotate 180° so that the swimmer 14 can read the data as he or she swims away from the wall, as shown in FIG. 11.

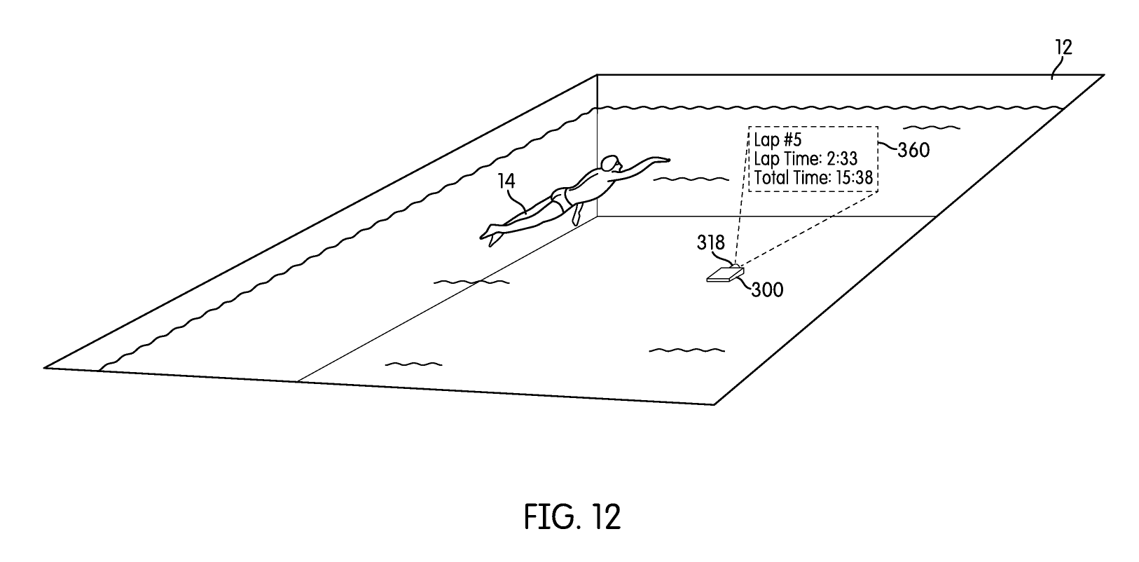

FIG. 12 is a schematic illustration of a variation on this concept: system 300, positioned on the bottom of the swimming pool 12, uses a projector 318 to protect its data on the sidewall of the swimming pool 12. The size of the data display 360, its content, and other display characteristics may be selected and controlled by the swimmer 14. In some cases, when the swimmer 14 completes a lap, the data display 360 may freeze for a moment or two so that the swimmer can view the displayed data, although timing functions will continue in the background, and after that moment or two of delay, the current data will be once again be displayed. Ultimately, data display continues until a predetermined number of laps is completed, until a predetermined amount of time has elapsed, or until data collection and display is manually terminated.

The above description assumes that data from the systems 16, 300 will be displayed in real time by a device directly connected to the systems 16, 300, such as an integrated display 26 or a projector or laser writer 328. However, in other embodiments, data may be communicated to or from outside devices or peripherals, as was described above with respect to FIG. 4. Communications between system 300 and peripherals in the water may be either radio frequency (RF) based or sound-based (e.g., via ultrasound transmissions), and may be encoded or encrypted so that they can only be interpreted and displayed by a specific peripheral or peripherals associated with a particular swimmer 14.

Some of those devices or peripherals may be associated with the swimmer 14. For example, the swimmer 14 may wear goggles with technology that provides a head-up display (HUD) that displays lap and timing data directly in the field of view of the swimmer 14. Additionally, if the swimmer 14 is wearing sensors that establish his or her vitals (heart rate, respiratory rate, etc.), that data may be displayed along with timing, lap count, and other data. As an alternative, a virtual retinal display (VRD) in a pair of goggles may be used to project the data display directly onto the retina or retinas of the swimmer 14. If a HUD, VRD, or other goggle-based display is used, the display may be provided for one eye or both eyes.

Thus, there are times when it may be informative or helpful if the swimmer 14 is wearing instruments and/or using personal displays while swimming. As was described briefly above, if instrumentation is desired or helpful, one of the better places to put it without interfering with swimming is in a swim cap.

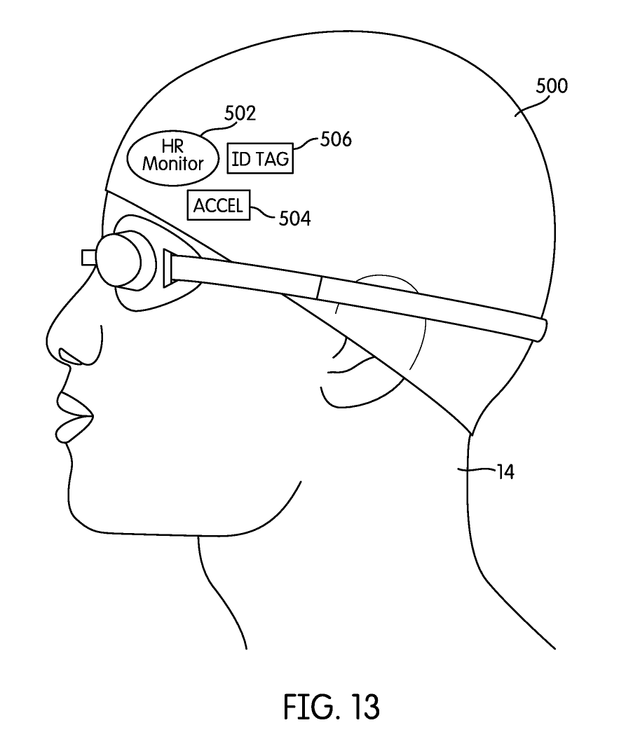

FIG. 13 illustrates a swimmer 14 wearing an instrumented swim cap 500. The swim cap 500 of the illustrated embodiment includes three sensors: a heart rate monitor 502, an accelerometer 504, and an identification tag or transponder, such as an RFID tag 506, although any number or type of sensors may be included. The swim cap 500 may be a standard cap that simply wedges the sensors 502, 504, 506 into the desired positions, or it may be a cap that is particularly adapted to hold the various sensors, in pockets or compartments, for example. Most swim caps 500 used will be elastic, typically made of either latex or silicone. Especially if the cap 500 used to secure sensors 502, 504, 506, it is extremely helpful if the cap 500 is fitted properly for the swimmer 14.

The heart rate monitor 502 would typically be inserted into the cap 500 so that it rests against the temple or on the forehead. Heart rate monitors 502 may use any technologies known in the art to sense heart rate, but whatever technologies are used to sense the heart rate (electrical/EKG, pulse oximetry, etc.), placement of a monitor 502 in a swim cap 500 may have certain advantages. For example, data on wrist-based heart rate monitors indicates that these types of monitors tend to slip against the skin and behave erratically in the water. The presence of an elastic swim cap 500, and the pressure it exerts on the heart rate monitor 502, may keep the heart rate monitor 502 in more direct, constant contact with the skin, resulting in better data.

The accelerometer 504 may be a uniaxial or triaxial accelerometer, and may be used to sense or derive a number of different pieces of data, including indicators of how and how often the swimmer 14 is moving his or her head, and indirectly, the respiratory rate of the swimmer 14, since swimmers move their head in order to breathe during swimming. Counting head movements may be translated into stroke count, which is the number of strokes taken per pool length—a useful measure of efficiency. The uses of the RFID tag 506 will be explained below in more detail.

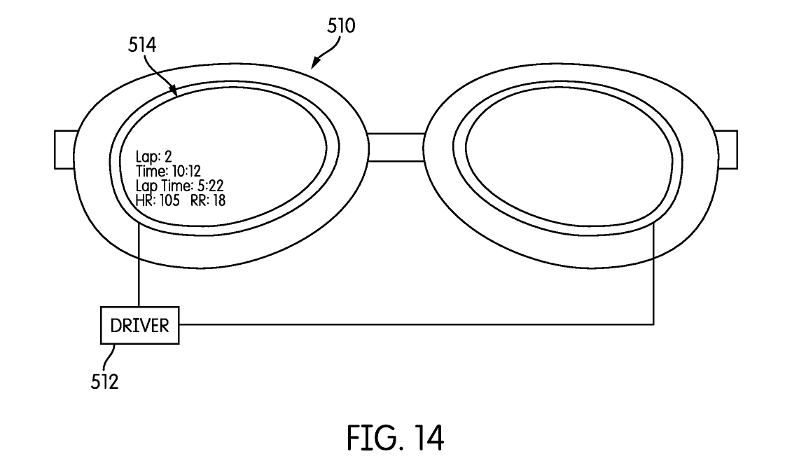

FIG. 14 is a schematic illustration of a HUD or VRD, generally indicated at 510. Driver hardware 512 either produces a HUD associated with a swimmer's goggles 514 or creates a VRD. In the illustration of FIG. 14, the HUD or VRD is in the left eye, and includes lap count, lap time, and total time, as well as heart rate and respiratory rate. In practice, individual swimmers 14 will be able to set the system 300 to show them any desired combination of information, including event and timing information and vital sign information. For example, useful heart rate derivatives may include heart rate mean for the elapsed swim, for the current lap, or for the most recently completed lap; heart rate relative to maximum rate; heart rate relative to a predefined target; calories burned; and hydration or dehydration status.

### Detection and Tracking of Multiple Swimmers

As was described above in some detail, systems 16, 300 according to embodiments of the invention may, in some cases, track multiple swimmers 14 at once. In many cases, differences in timing between two or more swimmers 14 may allow the systems 16, 300 to draw inferences in order to discriminate between the swimmers 14. However, as was also noted above, in situations where there are potentially others in a lane, or a number of swimmers 14 to be tracked, some form of marker is useful.

If the sensor used to detect the swimmers 14 is a camera 22, 24, the swimmers 14 may have a visually-identifiable and unique pattern on their swim suits or swim caps. That pattern would be detected and used to distinguish one swimmer 14 from another. However, as was described briefly above, a specific identifier, such as an RFID tag, may be used. The RFID tag may be either active or passive and, as was described above, system 300 may include an appropriate RFID reader 326 to interrogate and process data from the tags.

There are a number of different types of RFID tags that may be used. Since it is generally preferable for the swimmer 14 not to wear unnecessary gear, in some embodiments, a small RFID tag may be placed inside or secured to a swim cap or clipped to the swim suit, inside or out. A number of very small RFID tags are on the market (e.g., manufactured by Oregon RFID of Portland, Oreg., United States), typically used in applications like tracking fish and wildlife, those may be particularly suitable.

When swimmers 14 are wearing ID tags, methods according to embodiments of the invention will generally track data individually by swimmer, attributing each turn or other lap-ending event to the swimmer 14 whose ID tag is detected. This allows multiple swimmers to share the same lane and to use one system 300 for detection purposes. Of course, even in this scenario, it may not be necessary for every swimmer to wear a tag: if one swimmer is not wearing an ID tag, system 300 will generally still accurately track that swimmer's laps and times by process of exclusion—i.e., by recognizing that those events are not associated with any of the swimmers 14 who are wearing ID tags, and thus must be associated with a different swimmer 14. As was described above, multiple swimmers 14 who are not wearing ID tags, along with some who are, may be tracked if their timing is offset enough that system 300 can distinguish between swimmers.

However, one advantage of multiple swimmers 14 wearing ID tags is that system 300 can track their laps and times regardless of when they enter and leave the pool, and regardless of their timing relative to other swimmers 14. This may be particularly useful in cases where one swimmer 14 passes another in the same lane. Moreover, while it may be advantageous for all of the swimmers 14 sharing one system 300 to enter their personal preferences and parameters prior to the start of any swim session, system 300 can begin tracking a swimmer 14 with an ID tag potentially as soon as he or she enters the swimming pool 12 (i.e., as soon as he or she enters the detection volume of system 300). Once that swimmer 14 is in appropriate proximity of system 300, his or her times, lap counts, and other results are displayed. If two swimmers 14 are sharing a lane and arrive in close proximity, their times, lap counts, and other information may be distinguished by using different colors, or different alphanumeric designations.

In some cases, instead of RFID tags, swimmers 14 may wear transponders, such as ultrasound transponders. If transponders are used, they will typically be small, as well as shaped and adapted to fit in a non-interfering position, such as within a swim cap or clipped to the swim suit, inside or out. Transponders may be differentiated using a variety of methods in order to uniquely identify each swimmer. For example, ultrasound transponders may be frequency-differentiated, time-differentiated, or may transmit coded pulses that uniquely identify them. Radio frequency transponders may also be used in some embodiments.

Depending on the characteristics and ranges of the various components of system 300, the detection range or detection volume 350 for lap counting and timing may differ from the range at which system 300 can identify or interrogate an ID tag for a particular swimmer 14. In some cases, system 300 may be able to track swimmers 14 at longer range and identify them only when they get closer to system 300. In other cases, the detection and tracking ranges may be identical, or nearly so.

In some embodiments, swimmers 14 may store preferred workout programs or parameters in the memory of system 300, and those workout programs may begin automatically when a particular ID tag associated with a particular swimmer 14 is detected. This may occur in single-swimmer or multiple-swimmer modes.

### Algorithmic Enhancements

In method 100 above, the system 16, 300 is looking for a specific change in noisy source data. That specific change, a drop in light intensity in the example above, is used as a single factor to determine that an event (e.g., the completion of a lap) has occurred (i.e., in task 1198; FIG. 6). In some cases, methods according to embodiments of the invention may use second-criteria authentication to establish that events have occurred. In other words, in addition to the primary change in the data that the systems 16, 300 and method 100 look for, a second change in the data may be used to confirm that an event has occurred.

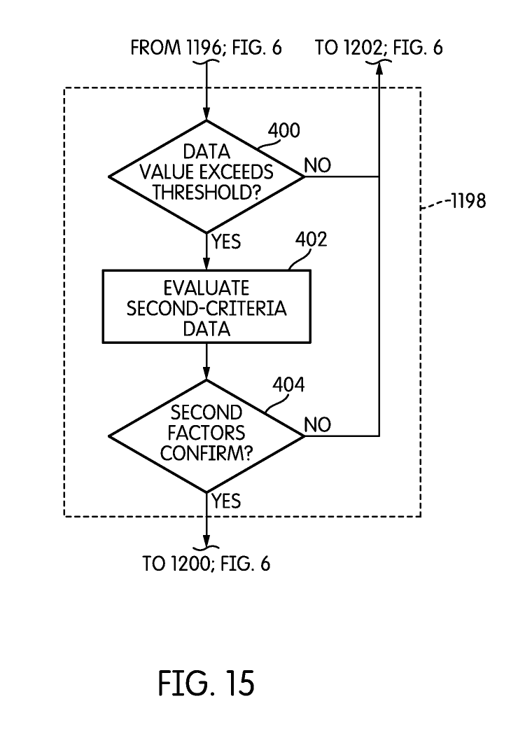

FIG. 15 is a flow diagram of the tasks involved in detecting an event using second-criteria authentication. For ease in description, the tasks described with respect to FIG. 14 may be assumed to occur during sub-task 1198 of FIG. 6, while the system 16, 300 is determining whether an event has occurred.

The tasks illustrated in FIG. 15 begin with sub-task 400, a decision task, in which it is determined whether or not a data value exceeds the defined threshold, as described above with respect to FIG. 6. If a data value does exceed the defined threshold (sub-task 400:YES), subtask 1198 continues with sub-task 402, in which second-criteria data is evaluated.

It should be understood that sub-task 402 and the sub-tasks that follow it are optional, and need not be executed. In some cases, for example, methods according to embodiments of the invention will invoke the sub-tasks illustrated in FIG. 1 only if an event is detected at a time when no event was expected, or if there is some other irregularity or exception in the processing of data.

In sub-task 402, the system 16, 300 evaluates second-criteria data. As the phrase is used here, “second-criteria data” can be any form of data, other than the primary data that is being monitored, that either indicates conclusively that an event has or has not occurred or provides circumstantial but strong evidence that an event has or has not occurred. Depending on the type of second-criteria data, these kind of “failsafe” algorithms may address and prevent both false positives and false negatives.

For example, with respect to swimming, a turn will always cause some form of localized disturbance in the water, and that disturbance should be perceptible at least to most forms of sensor—e.g., an optically-based method will see it as a change in the ambient light conditions around the camera, and methods based on sound, sonar, and laser-based detection will also perceive it. If a settledown period does not occur after a data value indicating a turn at a point in time when a turn was expected, then it may be assumed that no turn has actually occurred. In other words, the detected turn was a false positive. Any disturbance that happens when no turn is expected can also be assumed to be a false positive.

In some cases, more algorithmic steps may be necessary in sub-task 402 in order to evaluate the second-criteria data, and more than one distinct kind of data may be considered as second-criteria data. For example, in the above description, the system 16, 300 checks for a disturbance indicating a turn and, if one is found, compares the current lap elapsed time with, e.g., an average lap completion time for the swimmer 14 in question, or a world's fastest time for the swimmer's gender, stroke, and distance. Thus, the system 16, 300 in this example considers both time data and data on the ambient conditions around the system 16, 300 or within its detection volume.

The tasks of FIG. 15 continue with sub-task 404, a decision task. If the second-criteria data confirms that an event has occurred (task 404:YES), method 100 continues with sub-task 1200 of FIG. 6 and records the event. If the second-criteria data cannot confirm that an event has occurred (task 404:NO), control returns to sub-task 1202 of FIG. 6 and data continues to accumulate.

As was described above, sub-task 1200 records that an event has occurred. In embodiments in which multiple swimmers 14 are being tracked, sub-task 1200 may also ascribe the event to a particular swimmer 14 and trigger display changes or other tasks.

In some situations, it may be helpful to assume an event has occurred, even if the data does not indicate that one has occurred. Such “imputed events” may be helpful, for example, if the athlete or swimmer's progress toward the defined point is not continuous, or if the athlete or swimmer 14 is likely to be interrupted. In those situations, an imputed event inserted into the data may be used to keep the overall lap count as correct as possible. This would be done at the option of the user. For example, a swimmer 14 could activate this option if his or her intervals are likely to be interrupted. When active, at a time threshold of, for example, 1.25 times the current ambient mean lap time, a turn will be inserted. Any imputed events that are added to the data will typically be labeled as such.

While portions of this description focus on swimming, and the methods described here have particular application to swimming, these systems and methods have broad application. First, as those of skill in the art will readily appreciate, these systems and methods may be used in any sport where lap timing and similar operations are used.

Beyond those applications, the methods described above may also have applications in other fields, and particularly in any situation that could benefit from the use of a learned ambient statistic, like a learned ambient mean, as an unbiased standard of comparison. For example, the same image-based detection techniques could be used in astronomy to find planets based on star perturbations and light dimming from planetary transits. They could also be used for automatically detecting movements, like movements of submarines and other types of military ships and vehicles, from satellite imagery. Finally, as was noted briefly above, the data analysis techniques are not limited to image or luminance data or applications involving increases or decreases in ambient light. To that end, these techniques may be used in some cyber-security applications to detect unusual activity; changes in the flow of any fluid medium (water, gas); polygraphy; physical security using changes in infrared or laser light; and medical abnormality detection. Basically, methods according to embodiments of the invention may be used in any application benefiting from detection of events that deviate from a continually updating norm, however noisy in signal, especially in real time.

Although the invention has been described with respect to certain embodiments, the description is intended to be exemplary, rather than limiting. Modifications and changes may be made, within the scope of the appended claims.

What is claimed is:

1. A system, comprising:
a tag adapted to be attached to a swimmer; and
a computing device adapted to be placed in a fixed location remote from the tagged swimmer to detect the tagged swimmer, the computing device including
at least one sensor adapted to perceive energy reflected from or transmitted by the tag, and
a set of computer-readable instructions on a non-transitory computer-readable medium coupled to or associated with the computing device that, when executed on the computing device, cause the computing device to
gather data from the fixed location indicating whether the tagged swimmer has passed a defined point to complete a lap using the at least one sensor,
transform the data using the computing device from a first form into a second form in which the data can be evaluated as a time series,
evaluate selected data points of the time series of data in real time using the computing device to establish at least one learned statistic that is updated continuously at a defined rate and that represents a set of ambient conditions around the defined point over one or more time spans of undisturbed data, the time spans being selected in real time during a time period of the data gathering and being within the time period of data gathering, and
detect that the tagged swimmer has passed the defined point in real time using the computing device by determining that the time series of data has deviated from the learned statistic in a specified way by more than a defined threshold, the defined threshold determined, at least in part, using the learned statistic, the deviation of the learned statistic in the specified way indicating that the tagged swimmer has moved through a detection volume of the at least one sensor.

2. The system of claim 1, further comprising at least two tags, each of the at least two tags being adapted to be attached to a different swimmer.

3. The system of claim 2, wherein the at least two tags each transmit a unique code or identifier to identify the different tagged swimmers.

4. The system of claim 3, wherein the at least two tags are ultrasonic transponders.

5. The system of claim 4, wherein the at least one sensor is an ultrasonic transducer.

6. The system of claim 2, wherein the at least two tags each produce a distinct optical signature.

7. The system of claim 2, wherein the at least two tags are RFID tags.

8. The system of claim 2, wherein the at least two tags are reflectors.

9. The system of claim 2, wherein the set of computer-readable instructions cause the computing system to determine at least a lap count and a lap time based on the detection.

10. The system of claim 9, wherein the set of computer-readable instructions cause the computing system to determine a mean lap time for a session.

11. The system of claim 9, wherein the set of computer-readable instructions cause the computing system to confirm that the tagged swimmer has passed the defined point in real time using the computing device in part by evaluating second-criteria data for evidence that the tagged swimmer has passed the defined point.

12. The system of claim 11, wherein said evaluating second-criteria data comprises comparing a velocity of the tagged swimmer with a predefined reference lap completion time.

13. The system of claim 12, wherein the predefined reference lap completion time is based on a world's fastest time for the tagged swimmer's stroke, gender, and age.

14. The system of claim 9, wherein the set of computer-readable instructions cause the computing system to impute, under predefined conditions, that the tagged swimmer has passed the defined point irrespective of the detection.

15. The system of claim 9, wherein the set of computer-readable instructions further causes the computing device to calculate at least an average velocity for each lap.

16. The system of claim 15, wherein:
the fixed location remote from the tagged swimmer comprises a wall or the bottom of a swimming pool; and
the set of computer-readable instructions cause the computing system to calculate a distance to the tagged swimmer and a velocity of the tagged swimmer based on output of the at least one sensor.

17. The system of claim 16, wherein:
the set of computer-readable instructions cause the computing system to track the tagged swimmer entering and within the detection volume based on the deviation of the learned statistic and the calculated distance to the tagged swimmer;
the defined point comprises a selectable point, line, or plane within the detection volume; and
the detection is based, at least in part, on the calculated distance.

18. The system of claim 17, wherein the set of computer-readable instructions cause the computing system to calculate a bearing to the tagged swimmer based on the output of the at least one sensor.

19. The system of claim 9, further comprising a projector coupled to the computing system, the projector being adapted to project data on a wall or the bottom of a swimming pool.

20. A system, comprising:
a pair of swim goggles having an informational display and being coupled to a first communication device;
a tag adapted to be attached to a swimmer;
a computing device adapted to be placed on a wall or the bottom of a swimming pool remote from the tagged swimmer to detect the tagged swimmer, the computing device including
at least one sensor adapted to perceive energy reflected from or transmitted by the tag,
a second communication device adapted to communicate with the first communication device of the pair of swim goggles,
a set of computer-readable instructions on a non-transitory computer-readable medium coupled to or associated with the computing device that, when executed on the computing device, cause the computing device to
define a detection volume using the at least one sensor,
define, or allow the tagged swimmer to preselect, a lap completion point, line, or plane within the detection volume,
track the tagged swimmer within the detection volume using output of the at least one sensor based on one or both of (1) a distance to the tagged swimmer calculated and updated in real time based on output of the at least one sensor, or (2) a time series model of conditions measured by the at least one sensor, the set of computer-readable instructions causing the computing device to determine and substantially continuously update the time series model in real time,
establish that the tagged swimmer has passed the lap completion point, line, or plane based on one or both of the distance or the time series model,
calculate at least a lap count and a lap time when the tagged swimmer has passed the lap completion point, line, or plane, and
transmit the lap count and the lap time to the first communication device.

21. The system of claim 20, wherein the informational display comprises a head-up display (HUD) or virtual retinal display (VRD).

22. The system of claim 20, further comprising at least two tags, each of the at least two tags being adapted to be attached to a different swimmer.

23. The system of claim 22, wherein the at least two tags each transmit a unique code or identifier to identify the different tagged swimmers.

24. The system of claim 23, wherein the at least two tags are ultrasonic transmitters.

25. The system of claim 24, wherein the at least one sensor is an ultrasonic transducer.

26. The system of claim 22, wherein the at least two tags each produce a distinct optical signature.

27. The system of claim 22, wherein the at least two tags are RFID tags.

28. The system of claim 22, wherein the at least two tags are radio frequency (RF) transmitters.

29. The system of claim 22, wherein the at least two tags are reflectors.

30. The system of claim 20, wherein the set of computer-readable instructions further causes the computing device to calculate at least an average velocity for each lap.

31. A system, comprising:
a tag adapted to be attached to a swimmer; and
a computing device adapted to be placed in a fixed location remote from the tagged swimmer to detect the tagged swimmer, the computing device including
at least one sensor adapted to perceive energy reflected from or transmitted by the tag, and
a set of computer-readable instructions on a non-transitory computer-readable medium coupled to or associated with the computing device that, when executed on the computing device, cause the computing device to
create a time series model of conditions measured by the at least one sensor and update the model continuously in real time, and
detect that the tagged swimmer has passed the defined point in real time using the computing device by identifying a deviation in the conditions measured by the at least one sensor using the model.

32. The system of claim 31, wherein the time series model is an accumulative time series model.
